(19) United States
(12) Patent Application Publication
(10) Pub. No.: US 2024/0352225 A1
(43) Pub. Date: Oct. 24, 2024

(54) STORED ELASTOMER COMPOSITES

(71) Applicant: Beyond Lotus LLC, Wilmington, DE (US)

(72) Inventors: Prachi A. Dhavale, Freemont, CA (US); Dhaval A. Doshi, Lexington, MA (US)

(21) Appl. No.: 18/580,446

(22) PCT Filed: Jul. 19, 2022
(86) PCT No.: PCT/US2022/037571

§ 371 Date: Jan. 18, 2024

Related U.S. Application Data
(60) Provisional application No. 63/223,772, filed on Jul. 20, 2021.
(60) Provisional application No. 63/352,501, filed on Jun. 15, 2022.

(51) Int. Cl. C08K 5/18; B65D 79/00; B65D 81/20; C08K 3/04; C08K 3/06

(52) U.S. Cl. CPC C08K 5/18; B65D 79/008; B65D 81/2076; C08K 3/04; C08K 3/06; C08K 2201/005; C08K 2201/008

(57) ABSTRACT

Disclosed herein are elastomer composites stored in a container or package. The composite is uncured and comprises at least one elastomer and at least one filler. The package or container comprises at least one wall surrounding the composite wherein the at least one wall comprises at least one oxygen barrier layer. Containers or packages having this oxygen barrier wall have an oxygen transmission rate of no more than 100 cm³/(m²·day·atm) at 23° C. and 0% relative humidity. Also disclosed are methods for storing elastomer composites with the packages or containers disclosed herein.

### FIELD OF THE INVENTION

Disclosed herein are elastomer composites that are stored or packaged in container(s) or package(s) having an oxygen barrier wall.

### BACKGROUND

Numerous products of commercial significance are formed of elastomeric compositions wherein reinforcing filler is dispersed in any of various synthetic elastomers, natural rubber or elastomer blends. Carbon black and silica, for example, are widely used to reinforce natural rubber and other elastomers. It is common to produce a masterbatch, that is, a premixture of reinforcing filler, elastomer, and various optional additives, such as extender oil. Such masterbatches are then compounded with processing and curing additives and upon curing, generate numerous products of commercial significance. Such products include, for example, pneumatic and non-pneumatic or solid tires for vehicles, including the tread portion including cap and base, undertread, innerliner, sidewall, wire skim, carcass and others. Other products include, for example, engine mounts, bushings, conveyor belts, windshield wipers, rubber components for aerospace and marine equipment, vehicle track elements, seals, liners, gaskets, wheels, bumpers, anti-vibration systems and the like.

A good dispersion of reinforcing filler in rubber compounds has been recognized as a factor in achieving mechanical strength and consistent elastomer composite and rubber compound performance. Rubber compounds are prepared from elastomer composites, which are an uncured mixture of filler(s) and elastomer(s), optionally with one or more additives. An elastomer composite, also known as a masterbatch, can be compounded with additional additives and curing agents and subsequently subjected to one or more vulcanization processes. As such, elastomer composites can be more susceptible to degradation compared to rubber compounds (cured), which presents a challenge when stored and/or shipped prior to vulcanization. Accordingly, there is a need to prevent substantial degradation of elastomer composites when storing for a long period of time.

### SUMMARY

One aspect is a packaged elastomer composite, comprising:
a sealed package containing the composite in an atmosphere having a partial pressure of oxygen of less than 21 kPa (e.g., less than 20 kPa, less than 15 kPa, less than 10 kPa, less than 7 kPa, or less than 5 kPa), wherein the composite is uncured and comprises at least one elastomer and at least one filler, wherein:
the package comprises at least one wall surrounding the composite wherein the at least one wall comprises at least one oxygen barrier layer such that the package has an oxygen transmission rate of no more than 100 cm³/(m²·day·atm) at 23° C. and 0% relative humidity (RH).

Another aspect is a method of storing an elastomer composite, comprising:
sealing the elastomer composite in a container and storing the composite in the sealed container for a time period of at least 5 days, wherein:
   the elastomer composite is uncured and comprises at least one elastomer and at least one filler; and
   the container comprises at least one wall surrounding the composite wherein the at least one wall comprises at least one oxygen barrier layer such that the container has an oxygen transmission rate of no more than 100 cm³/(m²·day·atm) at 23° C. and 0% relative humidity

Another aspect is a method of maintaining or enhancing at least one property of an elastomer composite or a compound formed from the composite, comprising:
storing the elastomer composite in a sealed container for a time period of at least 5 days, wherein:
   the elastomer composite is uncured and comprises at least one elastomer and at least one filler; and
   the container comprises at least one wall surrounding the composite wherein the at least one wall comprises at least one oxygen barrier layer such that the container has an oxygen transmission rate of no more than 100 cm³/(m²·day·atm) at 23° C. and 0% relative humidity.

With regard to any aspect or method or embodiment disclosed herein, where applicable, the packaged elastomer composite or methods disclosed herein (e.g., methods of storing an elastomer composite or methods of maintaining or enhancing at least one property of an elastomer composite or a compound formed from the composite) can further comprise any one or more of the following embodiments: the atmosphere in the package or container has a partial pressure of oxygen of no more than 7 kPa or no more than 5 kPa; the atmosphere in the package or container comprises at least 90% of at least one gas that is nonreactive with the elastomer composite; the at least one gas that is nonreactive with the elastomer composite is selected from nitrogen, argon, helium, xenon, and carbon dioxide; the sealed package or container is under vacuum.

With regard to any aspect or method or embodiment disclosed herein, where applicable, the packaged elastomer composite or methods disclosed herein can further comprise any one or more of the following embodiments: the at least one oxygen barrier layer comprises a material selected from polyamide, polyethylene, polyethylene terephthalate, polyethylene naphthalate, aluminum, poly(ethylene vinyl alcohol), poly(vinylidene chloride), polyacrylonitrile, and blends thereof and metallized layers thereof; the at least one oxygen barrier layer comprises a material selected from polyamide, poly(ethylene vinyl alcohol), poly(vinylidene chloride), polyacrylonitrile, metals, and blends thereof and metallized layers thereof; the at least one oxygen barrier layer comprises a metallized layer or a metal layer; the at least one wall does not contain a metallized layer or a metal layer; the at least one oxygen barrier layer comprises a material selected from metals, metal alloys, ceramics carbon-based nanomaterials, and melamine-based materials; the at least one wall is a single layer wall that is the oxygen barrier layer; the at least one wall comprises two or more layers, wherein at least one of the layers is the oxygen barrier layer; the at least one wall is flexible; the at least one wall is rigid; the interior of the package has a volume of at least 10 L or at least 50 L.

With regard to any aspect or method or embodiment disclosed herein, where applicable, the packaged elastomer composite or methods disclosed herein can further comprise any one or more of the following embodiments: the composite comprises an antidegradant present in an amount of at least 0.5 phr, e.g., an amount ranging from 0.5 phr to 10 phr or an amount ranging from 0.5 phr to 3 phr, or other ranges disclosed herein; the composite is substantially free of antidegradants; the composite has a moisture content ranging from 3% to 20% by weight relative to the total weight of the composite; the package further contains at least one oxygen scavenger; the at least one oxygen scavenger is contained in a sachet permeable to oxygen; the sachet is adhered to an inner wall of the package; the at least one oxygen scavenger is selected from metal powders, ascorbic acids and salts thereof, and catechol.

With regard to any aspect or method or embodiment disclosed herein, where applicable, the packaged elastomer composite or methods disclosed herein can further comprise any one or more of the following embodiments: the at least one filler is selected from carbonaceous materials, carbon black, silica, bio-based fillers, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, carbon nanostructures, reclaimed carbon, or combinations thereof, and coated and chemically treated materials thereof; the at least one filler is selected from rice husk silica, lignin, nanocellulose, and hydrothermal carbon; the at least one filler is selected from carbon black, silica, and silicon-treated carbon black.

With regard to any aspect or method or embodiment disclosed herein, where applicable, the packaged elastomer composite or methods disclosed herein can further comprise any one or more of the following embodiments: the at least one elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof; the at least one elastomer is selected from diene-based elastomers; the at least one elastomer is selected from natural rubber, polyisoprene rubber, butadiene rubber, and blends thereof; the composite comprises the at least one elastomer comprising at least 30% natural rubber and the at least one filler comprising at least 50% carbon black; the composite further comprises curing agents.

With regard to any aspect or method or embodiment disclosed herein, where applicable, the packaged elastomer composite or methods disclosed herein can further comprise any one or more of the following embodiments: the composite has a Payne ratio of at least 1.1, wherein the Payne ratio is G′(0.3%)/G′(51.5%), wherein G′(0.3%) is a dynamic storage modulus measured at 0.3% strain amplitude and G′(51.5%) is a dynamic storage modulus measured at 51.5% strain amplitude; the composite has macrodispersion d₉₀ of no more than 80 μm, wherein d₉₀ is the area-equivalent diameter (μm) of particles of the filler in the composite.

With regard to any aspect or method or embodiment disclosed herein, where applicable, the packaged elastomer composite or methods disclosed herein can further comprise any one or more of the following embodiments: the composite is a heat-treated composite; an amount of oxygen in the package or container atmosphere is no more than 75 mmol/kg elastomer composite; the composite has been packaged or stored or aged for a time period of at least 5 days or at least 14 days or other time periods disclosed herein.

With regard to any aspect or method or embodiment disclosed herein, where applicable, the packaged elastomer composite or methods disclosed herein can further comprise any one or more of the following embodiments: prior to sealing the package or container, the interior of the package or container is flushed with at least one gas that is nonreactive with the composite and/or subjected to a vacuum; prior to sealing the package or container, the composite is heat-treated at a temperature of at least 40° C.; at the time of the sealing the package or container housing the composite, the composite has a probe temperature of at least 40° C.; the composite is prepared by combining at least a solid elastomer and a wet filler comprising a filler and a liquid, wherein the liquid is present in an amount of at least 15% by weight based on total weight of wet filler.

With regard to any aspect or method or embodiment disclosed herein, where applicable, the packaged elastomer composite or methods disclosed herein can further comprise any one or more of the following embodiments: the stored elastomer composite or a compound formed from the stored elastomer composite has a Payne ratio that is reduced by at least 10% relative to the Payne ratio of the composite prior to sealing the package, wherein the Payne ratio is G′(0.3%)/G′(51.5%), wherein G′(0.3%) is a dynamic storage modulus measured at 0.3% strain amplitude and G′(51.5%) is a dynamic storage modulus measured at 51.5% strain amplitude; the compound formed from the stored elastomer composite has a maximum tan δ value that is reduced by at least 10% relative to the maximum tan δ value of the composite prior to sealing the package.

With regard to any aspect or method or embodiment disclosed herein, where applicable, the packaged elastomer composite or methods disclosed herein can further comprise any one or more of the following embodiments: the composite is the product formed by incorporating at least one linking agent during the mixing of the at least one elastomer with the at least one filler; the composite is the product formed by incorporating at least one linking agent during the mixing of the at least one elastomer with the at least one filler; the composite further comprises at least one linking agent.

### DETAILED DESCRIPTION

Elastomers (e.g., diene-based elastomers) are known to degrade in the presence of air/oxygen. Degradation can take the form of scission and/or or crosslinking of polymer chains, which can affect rubber properties. Elastomer composites can be cured in the presence of curing agents, such as sulfur, to effect crosslinking, resulting in a vulcanizate that is hardened (with respect to the composite) and has greater stability with respect to degradation; degradation of vulcanizates can still occur but may have less influence on certain performance attributes compared to the influence from degradation of uncured composites. However, there may be a need to store (and/or transport) uncured elastomer composites for long periods of time (e.g., 3, 6, 9 months, or 1 or 2 years). Moreover, the increased temperatures that are often present in warehouses or during transport (trucks, shipping containers) can accelerate the rate of degradation. To reduce this rate, composites can be stored in refrigerators or under air conditioning. Such storage solutions, however, require excessive energy expenditures and refrigeration equipment.

It was not previously recognized that high barrier oxygen materials could provide an atmosphere with a low oxygen content for a sufficient period of time such that the rubber properties of uncured composites comprising rubber and filler and compounds formed from such composites are effectively maintained or even in certain instances, surprisingly, improved. As such, it is not typical in the industry to store such elastomers or composites under a low oxygen environment. The improvement can result in rubber properties that are enhanced by at least 5% or at least 10%, where the enhancement can be an increase in value (e.g. tensile stress ratio), or a decrease in value (e.g., hysteresis as indicated by maximum tan δ, Payne Effect, and/or Payne Ratio).

Disclosed herein are packaged elastomer composites (or stored or aged elastomer composites) and methods for storing and/or packaging such composites, and methods for maintaining and/or enhancing (improving) at least one rubber property of the composite or rubber compound formed from such stored or packaged composites. The rubber properties referred to herein can be those of the composite itself or of a rubber compound formed from the composite, in which the rubber compound results from vulcanizing the elastomer composite (vulcanizate), i.e., curing the composite in the presence of curing agents (curatives) such as sulfur, peroxides, etc.

Disclosed herein is a packaged elastomer composite, comprising:
a sealed package containing the composite in an atmosphere having a partial pressure of oxygen of less than 10 kPa, wherein the composite is uncured and comprises at least one elastomer and at least one filler, wherein:
the package comprises at least one wall surrounding the composite wherein the at least one wall comprises at least one oxygen barrier layer such that the package has an oxygen transmission rate of no more than 100 cm³/(m²·day·atm) at 23° C. and 0% relative humidity.

Accordingly, one aspect provides a composite sealed in a container or package containing or housing the composite, wherein the container or package comprises at least one wall surrounding the composite and the at least one wall comprises at least one oxygen barrier layer such that the container or package maintains a low oxygen content over a period of time. A wall can comprise a single layer that is the oxygen barrier layer or can comprise multiple layers (two or more layers) at least one of which is the oxygen barrier layer. An oxygen barrier layer substantially reduces the rate of oxygen transport from the outside (exterior) of the container to the inside (interior) of the container. By limiting the amount of oxygen exposed to the composite via container(s) or package(s) having an oxygen barrier wall (comprising at least one oxygen barrier layers), degradation of the composite can be substantially arrested.

The composites disclosed herein are stored and/or packaged and/or contained in one or more containers or packages that surround and house the elastomer composite and can be of any shape or size so long as they confer the desired oxygen barrier properties. The container can be a package (e.g., box, crate, bag) or any chamber including a glove box, room, etc. of any volume in which (molecular) oxygen in the interior can be maintained at a desired amount. In one aspect, the container or package has an oxygen transmission rate (OTR) of no more than 100 cm³/(m²·day·atm) at standard temperature and pressure. The oxygen transmission rate of the container or package can be determined from the oxygen barrier properties of the wall that comprises the oxygen barrier layer (oxygen barrier wall). Oxygen transmission rates can be determined according to ASTM D3985, which can be performed under conditions such as 73° F. and 0% relative humidity at sea level. In other alternatives, oxygen transmission rate can be determined or reported at 50% relative humidity, or at 65% relative humidity. As an option, the at least one wall can have an oxygen transmission rate of no more than 100 cm³/(m²·day·atm) at 23° C. (73° F.) and 0% relative humidity (RH), e.g., no more than 50, no more than 10, no more than 5, no more than 1, no more than 0.5, no more than 0.1, no more than 0.05, no more than 0.01, no more than 0.005, or no more than 0.001 cm³/(m²·day·atm) at 23° C. (0% relative humidity).

The wall of the container or package can comprise one or more sections that when sealed form the container. For example, a typical box would contain top and bottom wall sections plus four sidewall sections. It is understood that the number of wall sections can vary, e.g., a single, cylindrical sidewall sections sealed to top and bottom wall sections, or a continuous wall constructed to fold along indentations to form the container or further joined with one or more wall sections. Any number of sidewall sections can be employed (hexagonal-shaped boxes or containers, wedge-shaped boxes or containers, etc.). A bag or pouch would typically contain one or more wall sections, e.g., two or more flexible wall sections that are joined to each other via the matching edges to form one or more sidewall sections (and optionally a bottom wall section) such that at least two unsealed edges form an opening that can be sealed (e.g., hermetically sealed) upon packaging.

As a more specific illustration, a flexible package can comprise two identical flexible wall sections with similar dimensions of length and width each having four edges to form a square or rectangular wall section. The two flexible wall sections can be adhered to each other by sealing three of the matching edges, the fourth edge remaining unsealed to provide an opening for inserting the elastomeric composite into the package. Typically, all the wall sections of a container (sidewall section, top, and/or bottom wall section) are made of the same materials; oxygen barrier properties of the wall (and the package) can then be determined from the oxygen transmission rate of any wall section. Variations may occur, e.g., a bottom wall section may include one or more structural support layers to confer additional strength, a top or sidewall section may be constructed to facilitate opening the container and/or sealable layers (e.g., heat sealable) or adhesives to seal (hermetically seal) a package. As a result, these sections can have different oxygen barrier properties. The oxygen transmission rate of the package can then be an area-weighted average over the entire surface of the container.

With regards to seals, sealing refers to hermetic seals that provide the package with O₂ barrier properties such that the oxygen transmission rate from the exterior to the interior of the package is no more than 100 cm³/(m²·day·atm) at 23° C. and 0% relative humidity, or other amounts disclosed herein. Hermetic seals, as one example, can be formed by heat-sealing two sealable layers together such as heat sealing sidewall edges together. A package that is hermetically sealed (e.g., sealed at edges) can have a similar or substantially the same oxygen transmission rate as the oxygen barrier wall.

A container or package having more than one wall can be two or more containers, e.g., a first container surrounding a second container that surrounds and houses the elastomer composite. Each container would comprise a wall that can be a single or multilayer wall. For example, a first container can have a wall with a first oxygen barrier property and a second container can have a wall with a second oxygen barrier property. As a specific example, one container (one wall) can comprise a flexible film (e.g., a liner) that surrounds and optionally conforms to the shape of the material to be packaged, resulting in a lined or wrapped material or shrink-wrapped material. A second container (or second wall) can comprise a less flexible or rigid material that surrounds the lined material to protect from breakage and/or deformation during storage (which can include transport). In any event, whether there are multiple walls, or multiple containers, each container can have oxygen barrier properties such that the elastomer composition is subjected to the desired oxygen barrier properties, e.g., an oxygen transmission rate of no more than 100 cm³/(m²·day·atm) at 23° C. and 0% relative humidity, or other values disclosed herein. For example, a composite can be housed within two walls, each having oxygen barrier properties, e.g., one wall that is a liner wrapping the elastomer composite, and a second wall that is a container that houses the wrapped composite. The oxygen transmission rate of each wall (of each container) may not be lower than 100 (cm³/m²·day·atm), but combined, the container comprising two walls (e.g., the liner and package) can achieve the desired oxygen transmission rate of no more than (100 cm³/m²·day·atm). For more than one container (or more than one wall) the overall oxygen transmission rate (OTR) can be determined from the equation:

$$OTR = 1 / \{ ( 1 / {OTR}_{wall 1} ) + ( 1 / {OTR}_{wall 2} ) + … \}$$

where “OTRwall₁” and “OTRwall₂” refer to the respective oxygen transmission rate of each container (each wall). The equation can apply to multiple walls or multiple oxygen barrier layers within one wall (e.g., shrink wrap or otherwise shape-conformable liner that is wrapped multiple times around the composite can be considered as multiple walls or multiple layers within a wall).

Optionally, one or more containers that do not have oxygen barrier properties can be used to house the elastomeric composite in addition to the container(s) having the oxygen barrier wall. For example, the additional container can be a flexible mesh or bag to support or maintain a shape of the composite, e.g., when the composite is in the form of frites or granules or the like. Alternatively, the additional container can be a wooden or paper or corrugated cardboard box with no or poor oxygen barrier properties (or other non-barrier material), or sheets or grids, or can be fibrous, such as cloth. The additional container(s) can be positioned either outside or inside (or both) the oxygen barrier container (i.e., container having the oxygen barrier wall) to provide additional structural support and/or otherwise facilitate shipping and/or handling.

The containers or packages disclosed herein can be of any volume or size desired. The interior of the container can have a volume (inner volume) of at least 1 L, at least 10 L, at least 20 L, or at least 50 L. The container can be as small as a big or as large as a sealed room or shipping container, e.g., ranging from 1 L to 40,000 L, from 1 L to 20,000 L, from 1 L to 10,000 L, from 1 L to 2,000 L, from 1 L to 100 L, from 1 L to 50 L, from 1 L to 20 L, from 1 L to 10 L. For two or more containers where one is housed within the other, the volume is that of the larger oxygen barrier container. For example, a shipping container can have a volume up to 20,000 L or up to 40,000 L, and a crate can have a volume up to 1500 L or up to 2000 L.

In another aspect, the oxygen barrier properties of the at least one wall can be selected by limiting the amount of oxygen exposed to the elastomer composite over a certain period of time to prevent substantial degradation to the composite. For example, by knowing the weight of elastomer composite present in the package or container, a maximum amount of oxygen relative to the amount of composite by weight can be calculated. As an option, the container or package comprises at least one wall comprising at least one oxygen barrier layer such that an amount of oxygen in the package is no more than 75 mmol/kg elastomer composite, e.g., no more than 60 mmol/kg elastomer composite, no more than 50 mmol/kg elastomer composite, no more than 40 mmol/kg elastomer composite, no more than 30 mmol/kg elastomer composite, no more than 20 mmol/kg elastomer composite, no more than 15 mmol/kg, no more than 10 mmol/kg, no more than 6 mmol/kg, no more than 5 mmol/kg, no more than 4 mmol/kg, no more than 3 mmol/kg, no more than 2 mmol/kg, or no more than 1 mmol/kg elastomer composite. The amount of oxygen present in a sealed container or package can be measured with an oxygen sensor (many types of which are commercially available) at or after the time the packaged is sealed. For example, the headspace of the container can be measured with a sensor having a needle that punctures the package through a resealable septum, which may be adhered on the outside of the package or built into the wall or through an adhesive sensor that can be inserted and mounted into the package before sealing. Exemplary oxygen sensors include CheckPoint® or OpTech® optical oxygen sensors available commercially from Ametek Mocon (Minnesota, USA). From the respective volumes of the container and the composite, as well as composite weight, the amount of oxygen in the container (e.g., in mmol) can be determined per composite weight (e.g., kg). As an option, the package volume is at least 1 L, or at least 10 L, or other volumes disclosed herein. As an option, the disclosed amount of oxygen per weight composite in the container or package is maintained over a time period of at least 5 days (e.g., from the time of sealing), or at least 7 days, at least 1 month, at least 3 months, at least 6 months, or at least 1 year, e.g., from 5 days to 1 year. Alternatively stated, at any period of time of at least 5 days or more (e.g., up to one year), the amount of oxygen present in the container is minimized at the levels disclosed herein, e.g., no more than 20 mmol/kg composite, or even less.

The number of moles of oxygen in in a closed container can be calculated according to equation (1):

$$( {[ {O}_{2} ]}_{meas} * {V}_{air} / 100 ) * ( 273 K / {T}_{container} ) * ( {P}_{container} / 101.3 kPa ) / 22.4 L \qquad ( 1 )$$

where [O₂]_{meas.} is the measured oxygen concentration (%), Vₐᵢᵣ is the volume of *air in the container (L), T_{container} is temperature inside the container at the time of measuring the oxygen concentration (K), and P_{container} is the pressure inside the container at the time of measuring the oxygen concentration (kPa).

For a container housing a composite, Vₐᵢᵣ can be determined by subtracting the volume of the composite from the volume of the container, where the volume of the composite can be calculated as weight of the composite/specific gravity of the composite. From the result of equation (1) and knowing the weight of the composite, the oxygen content per weight composite (mmol/kg composite) can be determined. In certain cases where the container is a flexible bag, storing the container under vacuum or partial may conform the container to the shape of the composite. In this situation, the volume of the container can be determined by methods well known in the art. For example, the volume of the container can be assumed to be the same as the volume of the composite.

As an option, oxygen content can be indicated as oxygen partial pressure. Partial pressures disclosed herein refer to values measured at ambient conditions, e.g., sea level and at 20° C. Under ambient conditions, the partial pressure of oxygen is calculated from the atmospheric pressure (101.3 kPa at sea level) multiplied by the percent atmospheric oxygen (21%).

As an option, the atmosphere initially present in the container or package at the time of sealing has a low oxygen content (e.g., immediately prior to or at the time the package is hermetically sealed). For example, atmosphere in the container can be modified to reduce the oxygen content in the interior of the package, i.e., the atmosphere in the container is a modified atmosphere. As an option, the interior of the container or package has an oxygen partial pressure of less than 21 kPa, less than 20 kPa, less than 19 kPa, less than 18 kPa, less than 17 kPa, less than 16 kPa, less than 15 kPa, less than 12 kPa, less than 10 kPa, less than 9 kPa, less than 8 kPa, less than 7 kPa, less than 6 kPa, less than 5 kPa, less than 4 kPa, less than 3 kPa, less than 2 kPa, or less than 1 kPa, which is indicative of a modified atmosphere. As an option, a modified atmosphere (e.g., low oxygen partial pressure) can be achieved by subjecting the inside or interior of the package to a vacuum such that the atmosphere in the container has an absolute pressure of no more than 90 kPa, e.g., no more than 80 kPa, no more than 70 kPa, no more than 60 kPa, no more than 50 kPa, no more than 40 kPa, no more than 30 kPa, no more than 20 kPa, no more than 10 kPa, or no more than 5 kPa. As another option, the atmosphere in the container can be modified by flushing with a non-reactive gas (e.g., non-reactive with the composite). Examples of non-reactive gases include inert gases such as nitrogen, argon, helium, xenon. Other non-reactive gases include carbon dioxide. The atmosphere can be modified with one or more flushing steps (e.g., two or three or more flushing steps). As another option, the atmosphere can be modified with a combination of one or more vacuum and flushing steps to achieve the low oxygen content values disclosed herein.

Alternatively, a low oxygen content of the atmosphere in the interior of the package or container can be determined from a difference in oxygen partial pressure between the exterior of the container or package and the interior of the package, where the atmosphere of the exterior would be greater than that of the interior. For example, the difference in oxygen partial pressure between the exterior and the interior of the container or package can be at least 1 kPa, e.g., at least 2 kPa, at least 3 kPa, at least 4 kPa, at least 5 kPa, at least 6 kPa, at least 7 kPa, at least 8 kPa, at least 9 kPa, at least 10 kPa, at least 11 kPa, at least 12 kPa, at least 13 kPa, at least 14 kPa, at least 15 kPa, at least 16 kPa, at least 17 kPa, or at least 18 kPa.

As another alternative, a low oxygen content in the package (container interior) can be indicated by the amount of (molecular) oxygen in the package e.g., number of moles (e.g., mmol) of oxygen per weight of elastomer composite (e.g., no more than 75 mmol/kg elastomer composite as discussed herein), volume of oxygen (or volume of oxygen per kg composite), or as a concentration of oxygen present in the atmosphere of the container interior, e.g., less than 7%, less than 5%, less than 3%, less than 2%, or less than 1%. Oxygen concentrations can be measured with an oxygen sensor as discussed herein.

As an option, the oxygen content of the container or package at the time of sealing can be modified by the inclusion of at least one oxygen scavenger in the container interior. Oxygen scavengers remove (traps, scavenges) oxygen from the atmosphere of a closed container and thereby lowers oxygen content. Oxygen scavengers can remove oxygen by reaction (e.g., via an oxidation reaction) or by entrapping oxygen. In another alternative, the atmosphere inside the container or package can be modified with vacuum and/or non-reactive gas and the elastomeric composite is further packaged with at least one oxygen scavenger. The oxygen content achieved by the use of oxygen scavengers depend on the amount of scavenger used; oxygen content achieved can be any value disclosed herein, e.g., levels of less than 21 kPa, or other levels disclosed herein. Oxygen scavengers can be packaged with the composite, e.g., contained or enclosed in a sachet. The sachet, which should be permeable to oxygen, can be placed adjacent the composite or adhered to an inner wall (interior) of the container or package. Exemplary oxygen scavengers include metals such as metal powders or iron filings, ascorbic acids and salts thereof, any of the antidegradants (e.g., antioxidants) disclosed herein, catechol, and other oxygen scavengers known in the art. The antidegradants can be combined with the elastomer during the mixing of elastomer with filler, as known in the art. For example, the composite can comprise antidegradant(s) as described herein. As another example, at least one wall of the package can comprise a material capable of oxygen scavenging. Examples of oxygen scavengers, oxygen barrier and scavenging packages, including package walls that comprise oxygen scavenging materials, can be found in Ahmed et al., Food Control, Volume 82, pp. 163-178 (2017), the disclosure of which is incorporated by reference herein. As an option, the only oxygen scavenger present is an antidegradant dispersed in the composite, as described herein.

The at least one wall (oxygen barrier wall) can comprise one or more layers, e.g., one or more sheets laminates, films, liners, panels, etc. The wall can be a single layer wall, which comprises a material conferring suitable oxygen barrier properties (oxygen barrier material), or a multilayer wall (two or more layers) in which at least one of the layers comprises an oxygen barrier material, i.e., the layer is an oxygen barrier layer. The layer(s) of a wall can be a film, panel, or laminate. Multi-layer walls can be formed by extrusion or co-extrusion, extrusion coating, lamination (e.g., adhesive lamination), use of adhesive, or deposition of one layer upon another, use of tie layers, metallization.

Oxygen barrier wall(s) (or layer(s)) can comprise a number of materials, the most common including polymers and/or metals. Polymeric oxygen barrier materials include polyamide (PA), polyethylene terephthalate (PET) and modified PET (e.g., glycol modified PET), polyethylene naphthalate (PEN), poly(ethylene vinyl alcohol) (EVOH), poly(vinylidene chloride) (PVdC), polyacrylonitrile, polyvinyl alcohol (PVOH), methyl acrylate, copolymers of acrylonitrile and methyl acrylate (e.g., Barex® resins, which are a copolymer of acrylonitrile and methyl acrylate grafted with nitrile rubber), cyclo-olefinic copolymer (COC), and blends thereof. Multilayer walls can comprise one or more oxygen barrier layers. One or more barrier layers or walls can be biaxially oriented, e.g., stretched along transverse directions to render the polymer chains aligned with the plane of the layer or wall. Biaxial orientation can afford additional strength, toughness, resistance to pressure, etc. (improved tensile properties) as the film is stretched to orient chains.

Other oxygen-barrier materials include those containing metals, e.g., metal layers. Metallized layers (designated with the prefix “m” such as mPET) can be formed by a process known as metallizing or metallization. In metallization, metals can be deposited on substrates by a number of methods where the substrate can be a polymeric material with a desired flexibility or rigidity. As an example, metallizing can involve the evaporation of metals such as aluminum and subsequent deposition (e.g., vacuum deposition, chemical vapor deposition) onto a substrate film on which thin metal layers are deposited. Other methods of depositing metal layers include sputtering and electroplating. Alternatively, thin metal layers can be formed and the metal layer adhered to one or more polymeric layers. Metals that can be used as metal layers or metallized layers include aluminum, tin, nickel, iron, silver, and alloys thereof, e.g., aluminum-zinc alloys, silver-zinc-aluminum alloys, copper-zinc alloys, etc. Other materials that can be deposited onto polymeric films besides metals include ceramics (e.g., metal oxides such as silicon oxides (SiOₓ) such as silica, aluminum oxides, zinc oxides, magnesium oxides, titanium oxides, kaolinites, glass, and clays), carbon-based materials such as carbon nanomaterials (e.g., carbon nanotubes and graphene materials including graphenes, graphene oxides, reduced graphene oxides), and melamine-based coating materials. Materials such as metals, ceramics, and carbon-based coatings can also be deposited as particles having submicron dimensions, e.g., ranging from 1 nm to 1000 nm, from 1 nm to 500 nm, from 1 nm to 300 nm, from 1 nm to 200 nm, or from 1 nm to 100 nm. As another alternative, the at least one wall does not contain a metallized layer or a metal layer.

Metal containers that can be joined/welded to form a hermetic seal can also provide oxygen barrier properties, e.g., stainless steel, tin, and aluminum. Containers comprising metals can also include other materials, such as glass, ceramics, plastics, etc., e.g., a glove box or a room or other chamber. Rigid containers can be formed from thermoplastic elastomers and thermoplastic vulcanizates. Thermoplastic elastomers (TPE) contain more than one type of polymer: an elastomer (providing elastic properties) and a second polymer that provides strength. Examples of TPEs include styrenic block copolymers, such as styrene-butadiene-styrene block copolymers, ethylene acrylic copolymers. Thermoplastic vulcanizates (TPVs) are a class of thermoplastic elastomers prepared by vulcanization or crosslinking with properties of cross-linked rubbers combined with melt processability of thermoplastics, resulting in a material that can have high compression and resistance to heat deformation. Examples of TPVs include Santoprene™ thermoplastic vulcanizates (ExxonMobil), a vulcanized ethylene propylene diene (EPDM) rubber in a thermoplastic matrix of polypropylene (PP). Rigid containers can be sealed with adhesive material or gaskets or o-rings or similar seal (e.g., nitrile rubber, butyl rubber, and the like).

The oxygen barrier wall or layer can optionally contain oxygen scavenging materials embedded in the layer itself. Such oxygen scavenging barrier layers are typically sandwiched between protective layers, which can function as structural and/or sealable layers. Alternatively, the film is capable of oxygen scavenging, i.e., oxygen scavengers are embedded in the oxygen barrier material, or the film is made of a material that can scavenge oxygen.

Suitable oxygen barrier properties of the at least one wall can be achieved by one or more factors, including type of wall or layer materials or layer arrangement (for multilayer wall). For multilayer walls, typical layered arrangements include a sealing layer as the innermost layer (e.g., polyethylenes such as polypropylene, LDPE, LLDPE, or ethylene vinyl acetate (EVA)), followed by the oxygen barrier layer (e.g., metal layer, polyamide) and a structural layer (e.g., PET, polyethylene) as an exterior layer.

Wall and layer thicknesses can also be selected to provide oxygen barrier properties (and other properties) of the at least one wall while factoring the overall package weight to reduce shipping costs. Wall thicknesses can be at least 10 μm and up to 10 cm, e.g., up to 5 cm for rigid packaging. For flexible packaging, the wall thicknesses can range from 10 μm to 250 μm, e.g., from 10 μm to 200 μm, from 10 μm to 150 μm, from 10 μm to 100 μm, or from 10 μm to 50 μm. For example, PVdC-coated films, EVOH-based films, polyamide films (e.g., Nylon), and metallized polymer films can have thicknesses ranging from 10 μm to 30 μm, e.g., from 15 μm to 30 μm. The oxygen barrier wall can have a thickness ranging from 5 μm to 50 μm, from 5 μm to 40 μm, from 5 μm to 40 μm, from 5 μm to 30 μm, or from 5 μm to 20 μm. Rigid packaging can have thicknesses of at least 250 μm, e.g., at least 500.

Single-layer walls can be provided in the form of a flexible film, e.g., a liner or shrink wrap, or can be a rigid film (e.g., metal containers, ceramic containers. Examples of flexible films include PVdC shrink/stretch films as liners, e.g., having a thickness of at least 30 μm, such as thickness ranging from 30 μm to 100 μm, from 30 μm to 75 μm, or from 30 μm to 50 μm.

For multilayer walls, any number of layers can be used, such as 2-layer, 3-layer, 4-layer, 5-layer, 6-layer, 7-layer, etc., up to 10 or 12 layers or more (e.g., up to 20 layers or even more). These layers can confer a number of properties including structural properties, odor and/or moisture barriers, oxygen barriers, sealable layers (e.g., heat sealable layers) and combinations thereof, selected to provide a desired flexibility or rigidity, transparency, and oxygen barrier level. Regardless of the number of layers, the resulting wall has the required oxygen barrier properties.

Regarding properties other than oxygen barrier properties, one or more layers can provide strength and/or rigidity and/or structural support, e.g., to prevent deformation or destruction to the oxygen barrier wall (e.g., puncture resistance). Some materials can provide more than one function. Examples of such layers include:
polyesters such as polyethylene terephathalate and polycarbonate,
polyethylenes (PE), such as high density polyethylene (HDPE), low density polyethylene (LDPE), very low density polyethylene (VLDPE), ultra low density polyethylene (ULDPE), or linear low density polyethylene (LLDPE)), and blends thereof
polypropylenes
polyvinyl chloride (PVC)
polylactic acid (PLA)
ethylene-(meth)acrylic acid copolymers (e.g., Surlyn® resins from DuPont)
acid copolymer resins (e.g., NUCREL™ resins from Dow, which are a terpolymers of ethylene, methacrylic acid, and acrylate], and
blends thereof.

For any of the above, corresponding metal or metallized layers can also be used, whether by adhesion, vacuum vapor deposition, CVD, sputtering, electroplating, or any other method of adhering a thin metal film to a polymer.

One or more layers of the multilayer wall can be a sealing or sealable layer (sealant). The sealable layer can allow panels (e.g., one or more of top, side, bottom panels) to be joined with each other along the edges. As an option, the sealable layer is a heat-sealable layer in which the application of heat deforms or melts the polymer, enabling adhesion. Alternatively, the sealable layer can be a laminate that adheres layers to each other. In a multilayer wall, the sealable layer is often positioned on one or both of the outer edges of a multilayer wall, e.g., the sealable layer can be the innermost layer (forms the interior wall), or the outer layer (forms the exterior wall). Examples of sealable layers include:
polyesters such as PET and metallized layers (e.g., mPET)
polyethylenes as disclosed above, such as low density polyethylene (LDPE), linear low density polyethylene (LLDPE), and HDPE, and metallized layers, e.g., mVLDPE
polypropylenes
ethylene-acrylic acid copolymers (e.g., NUCREL™ resins),
ethylene-(meth)acrylic acid copolymers (e.g., Surlyn® resins),
ethyl vinyl acetate (EVA), and
blends thereof.

Alternatively, adhesives can be coated or laminated on the layers to improve adhesion between the layers (such as adhesives coating oxygen barrier layers and/or structural layers).

The sealable layer can join or otherwise adhere to one or more adjacent sealable layer(s) to form a hermetic seal that provides barrier properties at similar to that of the barrier wall. Alternatively, the sealing layer can be one that has good adherence to and supports an adhesive. Certain sealable layers can also function as structural layers, e.g., polyesters, polyethylenes (e.g., LDPE, LLDPE, HDPE), polypropylenes, ethylene-(meth)acrylic acid copolymers EVA, and others known in the art.

One or more layers in a multi-layer wall can be a moisture barrier to prevent water from either entering or exiting (depending on the elastomer composite), e.g., LDPE, LLDPE. Other types of layers can be used to prevent entry of other chemical vapors and/or light and/or other undesired elements (e.g., polyamide and EVOH). Processability, color/transparency, odor barriers, are also other factors for selecting layers.

For example, multilayer walls can include the following layer arrangements (interior of container to exterior of container proceeds in the left to right direction; “|” designates the interface between layers):
(i) sealable layer|O₂ barrier|sealable layer
(ii) structural layer|O₂ barrier|sealable layer
(iii) sealable layer|O₂ barrier|structural layer
(iv) 1^{st} O₂ barrier|structural layer|2^{nd} O₂ barrier|sealable layer
(v) structural and/or sealable layer|1^{st} O₂ barrier|2^{nd} O₂ barrier|structural and/or sealable layer
(vi) structural and/or sealable layer|O₂ barrier|moisture barrier
(vil) structural and/or sealable layer|O₂ barrier|moisture barrier|structural and/or sealable layer
(viii) structural and/or sealable layer|O₂ barrier+moisture barrier

While three- or four-layer arrangements are illustrated, one or more additional layers can be provided to supplement any of the above arrangements. For example, adhesive layers or laminates can be added between oxygen barrier layers and structural and/or sealable layers. Any number of layers for oxygen barrier walls are known in the art, e.g., single layer, 2-layer, 3-layer, 4-layer, 5-layer, 6-layer, 7-layer, or more, e.g., 10-layer and even 20-layer walls (or more).

A multi-layer wall can comprise more than one O₂ barrier layer (e.g., 1^{st} and 2^{nd} O₂ barrier layers, or even 3^{rd} or 4^{th} oxygen barrier layers or more). Where there are two or more O₂ barrier layers, the materials forming each O₂ barrier layer can be the same or different. For example, each of the O₂ barrier layers can be (or comprise) polyamide (PA), poly(ethylene vinyl alcohol) (EVOH), poly(vinylidene chloride) (PVdC), polyvinyl alcohol (PVOH), methyl acrylate, or metallized layers such as mPET, mPA, mPE, and blends thereof, or metal layers (e.g., aluminum layer); the structural layer can be HDPE, LDPE, VLDPE, ULDPE, LLDPE, polypropylene, PVC, PET, and blends thereof; the sealable layer can be LDPE, LLDPE, HDPE, polypropylene, and EVA.

Optionally, any or all of the layers, or the oxygen barrier layer, can be biaxially oriented (“Bo”).

Specific examples include:
PA|PE|Aluminum foil|PE|LLDPE
PE|EVOH|PE
LLDPE|Nylon|EVOH|Nylon|LLDPE
EVA|PA|EVA
EVA|PA|mPET
EVA|PA|mPP|LLDPE
BoPP|LDPE|mBoPP|SURLYN
where “BoPP” refers to biaxially oriented polypropylene, “m” refers to metallized layers, and “SURLYN” refers to Surlyn® resins. One or more additional layers can be provided to supplement any of the above arrangements.

The desired oxygen partial pressures in the sealed container can be achieved in a variety of ways. Methods of removing oxygen from sealed containers (or containers to be sealed) are known in the art. As an option, the interior of the container (or inner contents or the inside of the container) or package can be subjected to a vacuum, flushed with a non-reactive gas (e.g., inert gas), exposed to oxygen scavengers, and combinations thereof. For example, the container or package can be vacuum-sealed with a device constructed to subject the inner contents to a vacuum and subsequently seal the package. Vacuum sealing machines (vacuum sealer) or vacuum heat-sealing machines (vacuum heat sealer) are known in the art for packaging, such as flexible packaging. One example of a vacuum sealer comprises two surface members that can open and close to clamp a substantially flat package opening. The surface members can comprise one bar that raises and lowers against a platform, in which the open end of the package is inserted between the bar and platform. Alternatively, two bars can be used, e.g., an upper bar pivotably mounted to a lower bar. In any option, one or both bars can include heating elements and/or pressure elements to effect sealing. Between the two surface members are one or more nozzles in communication with a vacuum pump and optionally an inert gas source. After filling the package with the elastomer composite, the unsealed edges of the package can be inserted between two bars of the vacuum sealer while inserting at least one retractable nozzle into the package opening. Clamping or engaging the two bars together can effectively seal the package opening and provide a tight fit around the at least one nozzle. A vacuum can be applied and optionally cycled with an inert gas flush. After applying the vacuum, the nozzle can be retracted and removed from the package opening. Immediately thereafter, heat can be applied through the heating and/or pressure elements to seal the package. For heating elements, the heat can soften a sealing layer of the package wall and/or an adhesive coated on the sealing layer. Alternatively, the package can be contained in a chamber capable of being placed under vacuum and/or an inert gas atmosphere, in which the chamber contains the bars that clamp and seal the open package edges. Examples of such vacuum heat sealers include those sold by AmeriVacs (San Diego, CA), such as the retractable nozzle vacuum sealer with gas purge. An alternate to heat and pressure, welding processes can be used. For example, CO₂ lasers can be used to heat and melt the polymeric layers, causing them to fuse.

As another example (e.g., generally for more rigid containers but can also be applied to flexible containers), the container or package can contain one or more ports or outlets providing gaseous communication between the inside of the package and a vacuum pump. The port can extend through a wall of the package and can include a collar (e.g., substantially circular collar) on the outer wall of the package (surface of the outer wall) to sealingly fit hosing or tubing that extends to the vacuum pump. The port can further comprise a valve, e.g., a one-way valve, through which air or other gases can be withdrawn from the inside of the container upon operation of the vacuum pump. As an option, the valve can be a two-way valve for filling a bag with nitrogen after evacuating the contents. Upon achieving a desired vacuum level, or desired partial pressure of oxygen, operation of the pump ceases and the valve operates to restrict air or oxygen from entering the container. Optionally, the collar can be sealingly fitted with a cap or other similar enclosure or closing member to further prevent oxygen from entering the package, e.g., at an oxygen transmission rate greater than that of the wall. The cap can be constructed of an oxygen barrier material and can be adhered to the collar via an adhesive material (e.g., a glue). As another option, the valve area can be covered with an adhesive in the absence of a cap.

Methods of storing or aging an elastomer composite are also disclosed herein. Storing of the sealed containers or packages can occur in a warehouse and the like and can include shipping/transporting processes. The method can comprise storing the elastomer composite in the sealed containers disclosed herein, e.g., containers or packages comprising at least one wall surrounding the composite wherein the at least one wall comprises at least one oxygen barrier layer such that the container has an oxygen transmission rate of no more than 100 cm³/(m²·day·atm) at 23° C. and 0% relative humidity and/or an amount of oxygen in the package is no more than 75 mmol/kg elastomer composite, or other ranges as disclosed herein. As disclosed herein the at least one wall is an oxygen (O₂) barrier wall comprising at least one layer that is an oxygen barrier. The methods disclosed herein can result in the elastomer composite maintaining or even enhancing at least one rubber property. Thus, also disclosed herein are also methods of maintaining or enhancing at least one rubber property of an elastomer composite or a compound formed from the composite comprising storing the composite in a sealed container for a time period of at least 5 days, or at least 14 days, or other time periods disclosed herein. For example, the storing can be performed under a low oxygen content atmosphere in one or more sealed containers having an oxygen barrier wall.

Disclosed herein are methods of storing an elastomer composite, comprising:
sealing the elastomer composite in a container and storing the composite in the sealed container for a time period of at least 5 days, wherein:
   the elastomer composite is uncured and comprises at least one elastomer and at least one filler; and
   the container comprises at least one wall surrounding the composite wherein the at least one wall comprises at least one oxygen barrier layer such that the container has an oxygen transmission rate of no more than 100 cm³/(m²·day·atm) at 23° C. and 0% relative humidity.

Also disclosed herein are methods of maintaining or enhancing at least one property of an elastomer composite or a compound formed from the composite, comprising:
storing the elastomer composite in a sealed container for a time period of at least 5 days, wherein:
   the elastomer composite is uncured and comprises at least one elastomer and at least one filler; and
   the container comprises at least one wall surrounding the composite wherein the at least one wall comprises at least one oxygen barrier layer such that the container has an oxygen transmission rate of no more than 100 cm³/(m²·day·atm) at 23° C. and 0% relative humidity.

Prior to sealing (and storing), the method can comprise subjecting the composite in the container or package to at least one step that modifies the atmosphere of the interior of the container to achieve an atmosphere having a low oxygen content. As an option, the atmosphere is modified by flushing the interior of the container with at least one gas that is nonreactive with the composite (a non-reactive gas), e.g., a gas that contains less than 10% oxygen, less than 7%, less than 5%, less than 2%, or less than 1% oxygen. Exemplary non-reactive gases include inert gases such as nitrogen, argon, helium, xenon, or other non-reactive gases such as carbon dioxide, including blends of such gases. Flushing involves replacing at least a portion of the air present in the package with the at least one non-reactive gas (e.g., nitrogen, argon, etc.) such that the atmosphere contains at least 90% of the non-reactive gas, e.g., at least 91%, at least 92%, at least 93%, at least 94%, at least 95%, at least 96%, at least 97%, at least 98%, or at least 99% of the non-reactive gas. Stated alternatively, the atmosphere contains at least 90% (or other amounts disclosed herein) of at least one gas that is nonreactive with the elastomer composite.

As another option, the atmosphere is modified by removing a substantial amount of oxygen from the container, e.g., by evacuating the container interior (or applying vacuum to container interior) by any of the methods disclosed herein or known in the art. The container interior can be placed at any desired vacuum level as disclosed herein where the evacuated container can have an absolute pressure of no more than 90 kPa, e.g., no more than 80 kPa, no more than 70 kPa, no more than 60 kPa, no more than 50 kPa, no more than 40 kPa, no more than 30 kPa, no more than 20 kPa, no more than 10 kPa, no more than 5 kPa, or no more than 1 kPa. In addition to gas flush and/or vacuum, or in the alternative, a sachet containing an oxygen scavenger can be placed in the container where over time, the scavenger removes oxygen from the interior and thereby reduces oxygen content from the container interior.

As an option, the atmosphere is modified by subjecting the composite in the container (the interior of the container that houses the composite) to at least one step of: flushing the container interior with at least one gas that is nonreactive with the composite and applying a vacuum to the container interior. The atmosphere modification can comprise one or a combination of these steps. For example, after the composite is placed in the interior of the container, the container interior can be flushed with a nonreactive gas(es) followed by or preceded by applying a vacuum to the container interior, where this sequence of flushing with inert gas/vacuum can be repeated as needed, e.g., one, two, three, four, or even more sequences of flushing the interior of the container (the composite in the container) with a non-reactive gas followed by applying a vacuum to the container interior, or one, two, three, four, or even more sequences of applying a vacuum to the container interior followed by flushing the container interior with a non-reactive gas. As an option, the final step after the one or more sequence(s) can be sealing the container under the vacuum, e.g., a vacuum-packed container or package (regardless of the previous sequence(s) applied). Alternatively, the final step after the one or more sequence(s) can be flushing the container interior with the non-reactive gas, resulting in the composite sealed in the container under an atmosphere comprising at least 90% of at least one gas that is nonreactive with the elastomer composite. As another option, a single or multiple steps of applying a vacuum to the container interior (without non-reactive gas flush) followed by sealing the container. Alternatively, a single or multiple flushing steps with at least one non-reactive gas (with no vacuum applied) can be performed followed by sealing the container (no vacuum applied).

The elastomer composite in the sealed container or package can be stored for at least 5 days or other time periods disclosed herein. The storage time period can be determined from the time of sealing. As an option, the elastomer composite can be stored for at least 7 days, at least 2 weeks (14 days), at least 1 month, at least 2 months, at least 3 months, at least 6 months, at least 9 months, or at least 1 year or two years or more, and potentially indefinitely. As another option, the elastomer composite can be stored for a time period ranging from 5 days to 2 years, from 5 days to 1 year, from 5 days to 6 months, from 5 days to 3 months, from 2 weeks (14 days) to 2 years, from 2 weeks (14 days) to 1 year, from 2 weeks (14 days) to 9 months, from 2 weeks (14 days) to 6 months, from 2 weeks (14 days) to 3 months, from 21 days to 1 year, from 21 days to 9 months, from 21 days to 6 months, from 21 days to 3 months, from 1 month to 1 year, from 1 month to 9 months, from 1 month to 6 months, from 1 month to 3 months, and other ranges in between.

As an option, the composite can be stored under low oxygen content (modified atmosphere) conditions immediately after mixing or compounding (within 15 min. after the composite has been discharged from a mixer or compounder) or within 1 h, within 2 h, within 3 h, within 6 h, within 1 day, within 1 week, or within 1 month (30 days) from being discharged from a mixer or compounder so long as composite degradation is not substantial. For example, the composite can be stored in air or in cold storage prior to packaging or longer-term storage or transport. Alternatively, the composite can be transported in air to a facility in which the composites can be transferred to packages or other conditions offering low oxygen content storage. As another option, the composite is sealed in the container under air in which the high oxygen barrier wall prevents the substantial ingress of oxygen into the container. The sealing in air can be performed within 1 h, within 2 h, within 3 h, within 6 h, within 1 day, within 1 week, or within 1 month (30 days) after being discharged from a mixer or compounder.

The elastomer composite can be stored in the package or container at any temperature ranging from 20° C. to 200° C. As an option, the packaged composite can be stored under ambient conditions (at temperatures ranging from 20° C. to 40° C. or from 20° C. to 30° C.), whether in a climate-controlled environment or in an area without climate control (e.g., warehouse, truck).

As an option, the composite can be stored in the container for at least 5 days at elevated temperatures, e.g., a temperature of at least 40° C., such as temperatures ranging from 40° C. to 200° C., from 40° C. to 180° C., from 40° C. to 150° C., from 40° C. to 120° C., from 40° C. to 100° C., from 40° C. to 90° C., from 40° C. to 75° C., from 50° C. to 200° C., from 50° C. to 180° C., from 50° C. to 150° C., from 50° C. to 120° C., from 50° C. to 100° C., from 50° C. to 90° C., from 50° C. to 75° C., from 60° C. to 200° C., from 60° C. to 180° C., from 60° C. to 150° C., from 60° C. to 120° C., from 60° C. to 100° C., or from 60° C. to 90° C. In certain embodiments, the composite can be stored at elevated temperatures for at least 7 days, at least 2 weeks (14 days), at least 3 weeks (21 days), or at least 1 month up to 6 months or up to 1 year. As an option, storage at elevated temperatures is performed for no longer than 1 month, no longer than 2 weeks, or no longer than 1 week, e.g., storage from 5 days to 1 month.

As an option, prior to the storing, the composite can be heated, e.g., a heat-treated composite under a substantially oxygen-free atmosphere, e.g., under inert gas or under vacuum, in which the oxygen concentration in the atmosphere is less than 7%, less than 5%, less than 2%, or less than 1%. Under such conditions, the heat treatment can occur for a time period at least 15 min., at least 30 min., at least 1 hour, at least 2 h, at least 3 h, at least 6 h, at least 12 h, at least 18 h, at least 1 day or at least 2 days and up to 5 days. The heating can occur at the elevated temperatures disclosed herein, e.g., temperatures of at least 40° C., at least 50° C., at least 60° C., at least 70° C., at least 80° C., at least 90° C., or other elevated temperatures disclosed herein. The upper temperature limit can be determined by the composition of the composite and/or the container used. For example, depending on whether the composites comprise certain synthetic rubbers (or blends containing synthetic rubbers) or a majority of natural rubber, the composite can be heated at temperatures up to 200° C., up to 180° C., up to 160° C., or up to 150° C. (e.g., from 40° C. to 160° C.

The heating or heat-treating can be performed in a chamber having a substantially oxygen-free atmosphere (e.g., oven, glove box) or in the container or package comprising the oxygen barrier wall(s). The composite can be heat-treated in an oven or glove box or other chamber and then transferred to the container or package for sealing and storing; the composite can be cooled to ambient temperatures (e.g., from 20-40° C. or from 20-30° C.) prior to transferring to the container or transferred at when the composite has an elevated temperature, as determined by probe temperatures disclosed herein. Alternatively, the composite can be heat-treated in the package having the oxygen barrier wall and cooled in the package. Depending on the temperature of the composite, heat-stabilized vacuum packaging may be used.

Accordingly, prior to the storing, the method comprises forming a heat-treated elastomer composite, comprising heating an uncured elastomer composite in an oxygen barrier container or package, as disclosed herein, at a temperature of at least 40° C. for a time period of no more than 5 days, wherein the elastomer composite comprises at least one elastomer and at least one filler and wherein at least one of the following applies:
(i) the container interior has a partial pressure of oxygen of less than 17 kPa,
(ii) the container interior has an amount of oxygen of no more than 10 mmol/kg elastomer composite,
(iii) the container interior has an oxygen concentration of less than 7%, e.g., less than 5%, less than 3%, less than 2%, or less than 1%.

As another option, the composite is discharged from the mixer and sealed under a modified atmosphere, e.g., having an oxygen partial pressure of less than 21 kPa (or other ranges disclosed herein), e.g., an atmosphere that contains at least 90% of the non-reactive gas such as a nitrogen atmosphere, or having an oxygen to elastomer ratio of no more than 75 mmol/kg elastomer composite, or under vacuum (e.g., container interior has an absolute pressure of no more than 90 kPa). The time period between discharging from the mixer and sealing under a modified atmosphere can be immediate (e.g., within 5 min., within 10 min., within 15 min.) or no more than 30 days, e.g., no more than 2 weeks, no more than 1 week, no more than 1 day, no more than 12 h, no more than 6 h, no more than 3 h, no more than 2 h, no more than 1 h or no more than 30 min. The time period is determined with regard to minimizing the amount of degradation of the composite.

As another option, the composite can be discharged from the mixer under a modified atmosphere (e.g., inert gas atmosphere such as nitrogen atmosphere) and maintained or stored under a modified atmosphere (e.g., discharged, transported, and sealed in a package, all steps occurring under a modified atmosphere). The composite that is discharged from the mixer (whether discharged into the modified atmosphere or transferred the modified atmosphere) can have a probe temperature of up to 200° C. (e.g., immediately upon discharge from a mixer) depending on mixing conditions and/or whether the composite is cooled.

The probe temperature of the composite is typically a bulk temperature of the composite and can be measured, e.g., by inserting a thermocouple or other temperature measuring device into the composite. As an option, at the time of sealing in the container or package, the composite can have a probe temperature ranging from 20° C. to 200° C., e.g., from 20° C. to 180° C., from 20° C. to 100° C., from 40° C. to 200° C., or from 40° C. to 100° C. Typically upon discharge, the composite can have a probe temperature ranging from 100° C. to 180° C. Alternatively, the discharged composite can be subjected to cooling and can have a probe temperature ranging from 20° C. to 60° C., e.g., from 20° C. to 50° C., from 20° C. to 50° C., or from 20° C. to 60° C. In other alternatives, the composite has a probe temperature ranging from 30° C. to 100° C., e.g., from 40° C. to 100° C., from 50° C. to 100° C., from 60° C. to 100° C., from 30° C. to 90° C., from 40° C. to 90° C., from 50° C. to 90° C., from 60° C. to 90° C. from 30° C. to 60° C., from 40° C. to 60° C. or from 30° C. to 50° C. or from 30° C. to 40° C.

The elastomer composite can be considered an uncured (e.g., unvulcanized or prior to vulcanization) mixture comprising filler(s) and elastomer(s), optionally with one or more additives, in which the additives are discussed in further detail herein. The composite that is packaged can be considered a mixture or masterbatch. The composite can be, as an option, an intermediate product that can be subjected to subsequent curing or vulcanization processes to obtain a rubber compound or a rubber article.

The elastomer composite comprises the filler dispersed in the elastomer. This composite can be prepared in a number of ways, including combining the at least one elastomer with the at least one filler in a mixer, such as an intermesh or tangential mixer (e.g., Banbury or Brabender mixer), an extruder, a roll mill, a continuous compounder, or other rubber mixing equipment. The filler(s) and/or elastomer(s) can be combined in dry form or in wet form. Dry mixing processes involve mixing solid elastomer with filler in a dry state (not wetted or dispersed in a liquid). The step of combining can involve or include providing a continuous flow under pressure of at least a first fluid that includes the at least one filler (a slurry), and a continuous flow of at least a second fluid that includes an elastomer latex; and combining the first fluid flow and the second fluid flow to distribute the filler within the elastomer latex. The mixed latex and filler slurry can be coagulated to form a wet crumb, which is subsequently dewatered to form the composite. This is also known as a “wet mix” process, which is described in a number of references, including U.S. Pat. Nos. 4,029,633; 3,048,559; 6,048,923; 6,929,783; 6,908,961; 4,271,213; 5,753,742; 6,521,691, and 8,586,651, the disclosures of which are incorporated by reference herein. The mixer can be a continuous mixer or other type of mixer.

As another alternative, PCT Publication No. WO 2020/247663 A1, the disclosure of which is incorporated by reference herein, describes a mixing process with solid elastomer and a wet filler that comprises a filler and a liquid. Under the conditions outlined in PCT Publication No. WO 2020/247663 A1, the mixing results in a composite comprising the filler dispersed in the elastomer in which the liquid content is sufficiently low to enable compounding and optionally additional post processing steps such as extruding, calendaring, milling, granulating, baling, compounding, and sheeting. Such compounding and post-processing steps can be performed on the elastomer composite regardless of the mixing method performed.

Composites can also be prepared by continuous mixing, as described in PCT Publ. Nos. WO 2018/219630, WO 2018/219631, WO 2020/001823, and WO 2020/247663 the disclosures of which are incorporated by reference herein.

In addition to filler and elastomer, the composite can comprise at least one additive selected from antidegradants, coupling agents, processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphenamides and thiazoles), vulcanizing agents (or curatives, to crosslink rubbers, e.g. sulfur, peroxides), and other rubber additives, such as, but not limit to, retarders, co-agents, peptizers, adhesion promoters, tackifiers, resins, flame retardants, colorants, and blowing agent. As an option, the composite does not include vulcanization agents, e.g., the composite further comprises at least one additive selected from antidegradants, coupling agents, processing aids, activators, accelerators, retarders, co-agents, peptizers, adhesion promoters (e.g., use of cobalt salts to promote adhesion of steel cord to rubber-based elastomers, such as those described in U.S. Pat. No. 5,221,559 and U.S. Pat. Publ. No. 2020/0361242, the disclosures of which are incorporated by reference herein), resins (e.g., tackifiers, traction resins), flame retardants, colorants, blowing agents, and additives to reduce heat build-up (HBU). As an option, the rubber chemicals can comprise processing aids and activators. As another option, the one or more other rubber chemicals are selected from zinc oxide, fatty acids, zinc salts of fatty acids, wax, accelerators, resins, and processing oil. Exemplary resins include those selected from one or more of C5 resins, C5-C9 resins, C9 resins, rosin resins, terpene resins, aromatic-modified terpene resins, dicyclopentadiene resins, alkylphenol resins, and resins disclosed in U.S. Pat. Nos. 10,738,178, 10,745,545, and U.S. Pat. Publ. No. 2015/0283854, the disclosures of which are incorporated by reference herein.

After initially forming the composite, e.g., with the dry mixing or wet mixing or solid elastomer/wet filler mixing or other mixing processes, the composites may optionally be compounded with additional ingredients such as one or more of antidegradants, zinc oxide, fatty acids, zinc salts of fatty acids, wax, accelerators, resins, coupling agents, and processing oil. As an option, the composite, prior to compounding (if any) can contain antidegradants that were added during the initial mixing processes in which filler was mixed and dispersed in the elastomer. Because antidegradants can function to react with oxygen to prevent degradation of the rubber, antidegradants can also be considered a type of oxygen scavenger. Antidegradants (e.g., antioxidants) can be present in the composite in an amount ranging from 0.5% to 5%, from 1% to 5%, from 0% to 3%, from 0.5% to 3%, from 1% to 3%, from 0% to 2%, from 0.5% to 2%, or from 1% to 2% based on the weight of the composite. Alternatively stated, antidegradants (e.g., antioxidants) can be present in the composite (either after the initial mixing or after compounding) in an amount ranging from 0.5 phr to 10 phr, from 0.5 phr to 5 phr, from 0.5 phr to 3 phr, from 0.5 phr to 2 phr, 1 phr to 10 phr, from 1 phr to 5 phr, from 1 phr to 3 phr, or from 1 phr to 2 phr.

As an option, the composite can comprise vulcanizing agents (or curing agents or curatives, to crosslink rubbers, e.g. sulfur, peroxides) in addition to any other additive disclosed herein, e.g., “green compounds.” With or without the vulcanizing (curing) agents, the composite that is packaged according to the parameters and methods disclosed herein is considered uncured until subjected to vulcanization processes.

As an option, the storing or packaging of the composite in the oxygen barrier containers disclosed herein may allow the composite to be substantially free of any antidegradant or antioxidant. Oxidation or reaction with oxygen is a factor in the degradation of elastomer composites. The removal of oxygen may render the addition of antidegradants or antioxidants as unnecessary. As an option, the composite that is substantially free of any antidegradant may contain antidegradant in an amount of no more than 1% by weight of the composite, e.g., no more than 0.5%, no more than 0.3%, no more than 0.2%, or no more than 0.1%, e.g., from 0.1% to 1%, from 0.2% to 1%, from 0.1% to 0.5%, from 0.2% to 0.5%, from 0.1% to 0.3%, from 0.1% to 0.1% by weight of the composite. Alternatively stated, the composite contains antidegradant(s) in an amount ranging from 0 phr to 0.5 phr, from 0.1 phr to 0.5 phr, from 0.2 phr to 0.5 phr, from 0 phr to 0.3 phr, from 0.1 phr to 0.3 phr, from 0 phr to 0.2 phr, or from 0 phr to 0.1 phr. In formulations that are substantially free of antidegradants (e.g., substantially free of antioxidants), the formulation can optionally comprise one or more other additives, such as zinc oxide, fatty acids, zinc salts of fatty acids, wax, accelerators, resins, coupling agents, processing oils, and/or vulcanizing agents.

As an option, the uncured composite consists essentially of or consists of the filler dispersed in the elastomer, or the uncured composite consists essentially of or consists of the filler dispersed in the elastomer and the antidegradant. As another option, the uncured composite consists essentially of or consists of the filler dispersed in the elastomer and the linking agent, or the uncured composite consists essentially of or consists of the filler dispersed in the elastomer and the antidegradant and the linking agent.

In certain embodiments, the composite may have excess moisture, such as those composites made according to PCT Publication No. WO 2020/247663. For example, the composite can have a moisture content ranging from 3% to 20%, e.g., from 4% to 20%, from 5% to 20%, from 3% to 10%, from 4% to 10%, from 5% to 10%, from 3% to 9%, from 3% to 8%, from 3% to 7%, from 3% to 6%, or from 3% to 5%. In the absence of an antidegradant, such composites are susceptible to mold formation. The containers and packages containing the oxygen barrier wall can enable the storage of such composites having excess moisture (even when substantially free of antidegradants) as the low oxygen content in the package interior can reduce the extent of mold formation (if any).

Upon packaging or storing the elastomer composite in containers comprising the oxygen barrier walls disclosed herein, the composite can be stored for at least 5 days, at least 1 week, at least 2 weeks, at least 3 weeks, at least 4 weeks, at least 3 months, at least 6 months, at least 9 months (e.g., from 5 days to 2 years or from 5 days to 1 year or other time periods disclosed herein), where such composites can be referred to as aged or stored composites.

The resulting stored or aged composite and/or rubber compounds made from the stored or aged composite can display similar properties (maintain at least one rubber property) or even enhanced or improved rubber properties after storage compared to the properties at the time of sealing (packaging) and/or compared to composites that were stored or aged at ambient conditions (e.g., ambient oxygen partial pressure, ambient absolute pressure, etc., such as composites stored under air). Corresponding compounds made from such stored composites can also achieve similar or even enhanced properties compared to compounds made from composites at the time of sealing and/or compared to compounds made from composites that were stored or aged under ambient conditions (e.g., stored in air). At the time of sealing, samples of composites can be subjected to various measurement techniques or compounded to form rubber compounds for which properties are measured or obtained. Such properties measured of composites at the time of packaging would be a control sample (rubber compounds formed from the control sample composite would be a control rubber compound). After storing or aging for a time period, such as the time periods disclosed herein, samples of the aged or stored composite and subsequently formed compound properties can be measured or obtained.

In certain instances, such rubber properties are maintained, e.g., degradation of properties of no more than 10%, no more than 5%, no more than 3%, no more than 2%, or no more than 1% the value at the time of packaging or sealing. In other instances, the aged or stored composite and corresponding compounds made from the aged or stored composite display enhanced values. The enhancement can be seen by rubber properties that are enhanced by at least 5% or at least 10% compared to the properties at the time of sealing or packaging and/or compared to composites that were stored or aged at ambient conditions (as well as for corresponding compounds made from such composites). The enhancement can be a beneficial decrease in value (e.g., Payne Effect or Payne Ratio of the composite or corresponding rubber compound or hysteresis of the rubber compound as indicated by maximum tan δ) or a beneficial increase in properties such as tensile strength, tensile stress or modulus ratio of the corresponding compound.

For example, the rheological properties of the composite (and compounds formed from such composites) can be enhanced due to storing of the composite in the high oxygen barrier containers disclosed herein. One example of such a property is the Payne Effect of the composite (unvulcanized), which can be indicated by the Payne ratio or Payne difference. Payne ratio, defined by G′(0.3%)/G′(51.5%), where G′(0.3%) is a dynamic storage modulus measured at 0.3% strain amplitude and G′(51.5%) is a dynamic storage modulus measured at 51.5% strain amplitude. Payne difference is the difference between G′(0.3%) and G′(51.5%). The rheological properties of the composite, such as the composite Payne ratio, can be measured prior to and after storing the composite for different time periods so long as the measurement is made before vulcanization. In some instances, after a period of at least 5 days (e.g., at least 14 days) from sealing or storing the package or container (or manufacture of the composite), e.g., at temperatures of at least 25° C., or at least 30° C., at least 40° C., at least 50° C., or at least 60° C., the elastomer composite has a Payne ratio, as defined by G′(0.3%)/G′(51.5%), that is reduced by at least 10% (e.g., at least 15% or at least 20%) relative to the Payne ratio of the composite 0 days from sealing the package. As an option, the composite has a Payne Ratio of at least 1, at least 1.1, at least 1.2, at least 1.3, at least 1.4, at least 1.5, or at least 2, e.g., a Payne Ratio ranging from 1 to 15, from 1 to 12, from 1.5 to 15, from 1.5 to 12, from 2 to 15, or from 2 to 12.

As an example, properties of the cured compound (formed from such aged or stored composites) can be beneficially enhanced as indicated by rubber compound properties, e.g., rheological properties such as a decrease in Payne ratio (by at least 10%), defined above, or a decrease in hysteresis (by at least 10%) of the rubber compound as indicated by maximum tan δ, or an increase by at least 10% of mechanical properties such as modulus ratio or tensile stress ratio, which is the ratio of tensile stress at 300% elongation (M300) to tensile stress at 100% elongation (M100), i.e., M300/M100.

The composite can be packaged after mixing and dispersing the filler and in the elastomer or after additional mixing stages in which the composite is compounded with one or more additives (e.g., antidegradants, coupling agents, processing aids, activators, accelerators, vulcanizing agents, as discussed in greater detail herein) so long as the composite is uncured. The composite can be packaged immediately after discharge from a mixer or after a period of time and at a temperature as disclosed herein, with minimal degradation.

When packaging composites having elevated bulk or probe temperatures, the package or container can be selected to withstand such hot-filling processes. Shrinkage or other deformation can occur upon cooling the composite in a package, particularly when the inner volume of the package is under reduced pressure, e.g., vacuum. Hot-fill packages are typically flexible and constructed to deform upon cooling. Heat-stabilized vacuum packaging can also be used. Alternatively, the package can be very rigid, such as a high Tg plastic, or one with thick walls (e.g., walls greater than 250 μm thickness), or a metal container.

The filler(s) and elastomer(s) that form the composite can be any filler and elastomer known in the industry. Elastomers include natural rubber (NR), functionalized natural rubber, synthetic elastomers such as styrene-butadiene rubber (SBR, e.g., solution SBR (SSBR), emulsion SBR (ESBR), or oil-extended SSBR (OESSBR)), functionalized styrene-butadiene rubber, polybutadiene rubber (BR), functionalized polybutadiene rubber, polyisoprene rubber (IR), ethylene-propylene rubber (EPDM), isobutylene-based elastomers (e.g., butyl rubber), halogenated butyl rubber, polychloroprene rubber, nitrile rubbers (NBR), hydrogenated nitrile rubber (HNBR), polysulfide rubber, polyacrylate elastomers, fluoroelastomers, perfluoroelastomers, silicone elastomers, and blends thereof. Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof.

As an option, the composite can comprise at least one elastomer that is subject to degradation upon exposure to oxygen, such as diene-based elastomers, which include natural rubber, styrene-butadiene rubber, butadiene rubber, isoprene rubber, and blends thereof. The composite can further include other elastomers that are not substantially susceptible to oxygen, as known in the art. As another option, the at least one elastomer comprises natural rubber (e.g., at least 20%, at least 30%, at least 40%, a least 50%, at least 60%, at least 70%, at least 80%, or at least 90% natural rubber) and can further comprise at least one synthetic elastomer. As an option, the at least one elastomer comprises natural rubber and further comprises at least one additional elastomer such as styrene-butadiene rubber, butadiene rubber, isoprene rubber or any of the synthetic elastomers known in the art or disclosed herein.

Any filler known in the art of elastomer composites can be used. The filler can be particulate or fibrous or plate-like. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher.

The filler can comprise at least one material that is selected from carbonaceous materials, carbon black, silica, biobased fillers such as nanocellulose and lignin, clays, nanoclays, metal oxides, metal carbonates, fillers from recycled materials including pyrolysis carbon, reclaimed carbon, and recovered carbon black (e.g., as defined in ASTM D8178-19, rCB), graphenes, graphene oxides, reduced graphene oxide (e.g., reduced graphene oxide worms as disclosed in PCT Publ. No. WO 2019/070514A1, or densified reduced graphene oxide granules as disclosed in U.S. Prov. Appl. No. 62/857,296, filed Jun. 5, 2019, and PCT Publ. No. WO 2020/247681, the disclosures of which are incorporated herein by reference), carbon nanotubes, single-wall carbon nanotubes, multi-wall carbon nanotubes, carbon nanostructures (CNS), fragments of carbon nanostructures, fractured multiwall carbon nanotubes (as disclosed in PCT Application No. PCT/US2021/27814, the disclosure of which is incorporated by reference herein) or combinations thereof, or corresponding coated materials or chemically-treated materials thereof (e.g., chemically-treated carbon black).

Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Publ. No. WO 2021/247153, the disclosures of which are incorporated by reference herein. Blends of fillers can also be used, e.g., blends of silica and carbon black, silica and silicon-treated carbon black, and carbon black and silicon-treated carbon black. The filler can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments. There is no limitation with respect to the type of filler (e.g., silica, carbon black, or other filler) that can be used.

The filler can comprise a fibrous filler including natural fibers, semi-synthetic fibers, and/or synthetic fibers (e.g., nanosized carbon filaments), such as short fibers disclosed in PCT Publ. No. WO 2021/153643, the disclosure of which is incorporated by reference herein. Other fibrous fillers include poly(p-phenylene terephthalamide) pulp, commercially available as Kevlar® pulp (Du Pont).

Other suitable bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and 10,428,218, the disclosures of which are incorporated by reference, herein), rice husk silica, carbon from methane pyrolysis, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure. As an option, the at least one filler is selected from rice husk silica, lignin, nanocellulose, and hydrothermal carbon.

There is no limitation with respect to the type of filler (e.g., silica, carbon black, or other filler disclosed herein) that can be used, including bio-based (derived from a biological source) and recycled materials (e.g., reclaimed carbon). Examples of coated fillers include those described in U.S. Pat. No. 10,519,298, the disclosure of which is incorporated by reference herein. Examples of chemically-treated fillers include fillers (e.g., carbon black) having attached at least one organic group (e.g., via a diazonium reaction) as described, for instance, in U.S. Pat. Nos. 5,554,739; 5,630,868; 5,672,198; 5,707,432; 5,851,280; 5,885,335; 5,895,522; 5,900,029; 5,922,118, the disclosures of which are incorporated by reference herein.

The filler can comprise silicon-treated carbon black, a silicon containing species, such as an oxide or carbide of silicon, that is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference. The silicon-treated carbon black can include silicon-containing regions primarily at the aggregate surface of the carbon black, but still be part of the carbon black and/or the silicon-treated carbon black can include silicon-containing regions distributed throughout the carbon black aggregate. The silicon-treated carbon black can be oxidized.

The at least one filler (e.g., carbon black, silica, silicon-treated carbon black, or any other fillers and combinations thereof disclosed herein) can be dispersed in the at least one elastomer at a loading ranging from 20 phr to 250 phr, e.g., from 20 phr to 240 phr, from 20 phr to 230 phr, from 20 phr to 220 phr, e.g., from 20 phr to 180 phr, from 20 phr to 150 phr, from 20 phr to 120 phr, from 20 phr to 100 phr, from 20 phr to 80 phr, from 20 phr to 60 phr, from 30 phr to 100 phr, from 30 phr to 80 phr, from 30 phr to 60 phr, from 40 phr to 100 phr, from 40 phr to 80 phr, or from 40 phr to 60 phr. Certain carbon-based nanomaterials, such as graphenes, graphene oxides, reduced graphene oxides carbon nanotubes, single-wall carbon nanotubes, multi-wall carbon nanotubes, carbon nanostructures, fragments of carbon nanostructures, fractured multiwall carbon nanotubes can be dispersed in the at least one elastomer at loadings of at least 0.1 phr, whether alone or with one or more non-carbon-based nanomaterials, such as carbon black, silica, silicon-treated carbon black, and other fillers and combinations as disclosed herein. The carbon-based nanomaterials can be dispersed in the at least one elastomer at loadings ranging from 0.1 phr to 50 phr, from 0.5 phr to 50 phr, from 0.5 phr to 40 phr, from 0.5 phr to 30 phr, from 0.5 phr to 20 phr, from 0.5 phr to 10 phr, from 0.5 phr to 5 phr, from 0.5 phr to 3 phr, from 0.5 phr to 2 phr, from 0.5 phr to 1 phr, from 1 phr to 20 phr, from 1 phr to 10 phr, from 1 phr to 5 phr, from 1 phr to 3 phr, or from 1 phr to 2 phr. Other ranges can be envisioned, such as ranges disclosed in PCT Publication No. WO 2020/247663 A1, PCT Publ. No. WO 2019/070514A1, PCT Application No. PCT/US2021/27814, the disclosures of which are incorporated by reference herein.

As an option, the at least one elastomer in the elastomer composite comprises at least 30% natural rubber (e.g., at least 40%, at least 50%, at least 60%, at least 70%, at least 80%, at least 90%, at least 95%, at least 99% natural rubber) and the at least one filler in the elastomer composite comprises at least 50% carbon black (e.g., at least 60%, at least 70%, at least 80%, at least 90%, at least 95%, at least 99% carbon black).

Where the filler comprises carbon black, e.g., at least 20%, at least 30%, at least 40%, at least 50%, at least 60%, at least 70%, at least 80%, at least 90%, at least 95% carbon black, or the filler is substantially all carbon black, the uncured composite can be the product formed by incorporating at least one linking agent. For example, the composite can be prepared by mixing at least filler, elastomer (or elastomer latex), and at least one linking agent, or the composite can further comprise at least one linking agent. Composites prepared in the presence of certain linking agents, such as those disclosed in PCT Appl. No. PCT/US21/62433, filed Dec. 8, 2021, the disclosure of which is incorporated by reference herein, can exhibit reduced degradation over time, e.g., over at least 5 days, at least 1 week, at least 2 weeks, at least 1 month (at least 30 days), at least 2 months, at least 30 months, and even at least 6 months (at least 180 days) up to 1 year (12 months) or even up to 2 years at temperatures of at least 20° C. Such reduced degradation can be at least partially additive with the benefits achieved by the storage/packaging methods disclosed herein. As an option, the composite further comprises at least one linking agent, for example, an uncured composite or masterbatch comprising filler and elastomer was prepared according to any method known in the art and then subjected to one or more compounding or other processing steps with at least one linking agent and optionally at least one additive (e.g., antidegradant or other additives disclosed herein) prior to forming a vulcanizate.

As an option, the linking agent(s) can be selected from compounds having at least two functional groups, wherein:
a first functional group is selected from —NR¹R², —N(R¹)(R²)(R³)⁺A⁻, —S—SO₃M¹, and structures represented by formula (I) and formula (II),

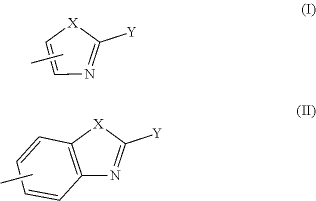

wherein A is chloride, bromide, iodide, hydroxyl, nitrate or acetate, X=NH, O, or S, Y=H, OR⁴, NR⁴R⁵, —SₙR⁴, and n is an integer selected from 1-6, and a second functional group is selected from thiocarbonyl, nitrile oxide, nitrone, nitrile imine, —S—SO₃M², —Sₓ—R⁶, —SH, —C(R⁶)═C(R⁷)—C(O)R⁸, —C(R⁶)═C(R⁷)—CO₂R⁸, —C(R⁶)═C(R⁷)—CO₂M², and
R¹-R⁸ are each independently selected from H and C₁-C₈ alkyl; M¹ and M² are each independently selected from H, Na⁺, K⁺, Li⁺, N(R′)₄⁺ wherein each R′ is independently selected from H and C₁-C₂₀ alkyl, and x is an integer selected from 1-8.

Without wishing to be bound by any theory, it is believed that while the mixing process with wet filler can enhance filler dispersion, the linking agent can interact with the filler and/or elastomer to create a stronger interaction between filler and elastomer. As an option, the linking agent can have at least two functional groups, in which the first and second functional groups can interact with the elastomer and/or the filler. The interaction can involve adsorption or a chemical bond, e.g., through ionic interactions, dipole-dipole interactions, hydrogen bonding, covalent bonds, etc. In the composite, the linking agent can be present in the same form as charged to the mixer or in a different form, e.g., if interacting with the filler and/or elastomer via a chemical bond.

The linking agent comprising at least two functional groups can comprise two, three, or four or more functional groups. In any of these embodiments, the linking agent comprises a first functional group that can be selected from —NR¹R², —N(R¹)(R²)(R³)⁺A⁻, —S—SO₃M¹, and structures represented by formula (I) and formula (II),

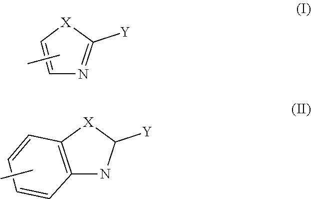

wherein A⁻ is chloride, bromide, iodide, hydroxyl, nitrate or acetate, X=NH, O, or S, Y=H, OR⁴, NR⁴R⁵, or SₙR⁴, and n is an integer selected from 1-6. In certain aspects, the first functional group can be selected from —NR¹R² (e.g., —NHR¹ or —NH₂), —CO₂M¹, and —S—SO₃M¹.

The linking agent can further include a second functional group, which can be selected from thiocarbonyl, nitrile oxide, nitrone, nitrile imine, —S—SO₃M², —Sₓ—R⁶, —SH, —C(R⁶)═C(R⁷)—C(O)R⁸, —C(R⁶)═C(R⁷)—CO₂R⁸, —C(R⁶)═C(R⁷)—CO₂M². In certain aspects, the second functional group can be selected from —S—SO₃M² and —CR⁶═CR⁷—CO₂M². Where the functional group is —CO₂M¹, and —S—SO₃M¹, —S—SO₃M², and —CR⁶═CR⁷—CO₂M², these can be selected from acids or salts thereof, e.g., M¹ and M² are each independently selected from H, Na⁺, K⁺, Li⁺, and N(R′)₄⁺ (e.g., ammonium salts where each R′ is independently selected from H and C₁-C₂₀ alkyl, such as C₁-C₁₂ alkyl or C₁-C₆ alkyl or C₁-C₄ alkyl, e.g., monoalkyl, dialkyl, trialkyl or tetralkyl ammonium salts). Where the linking agent contains two or more M¹ or two or more M² groups, each M¹ or M² can be independently selected from H, Na⁺, K⁺, Li⁺, and N(R′)₄⁺.

In the embodiments described herein, R¹-R⁸ are each independently selected from H and C₁-C₈ alkyl; M¹ and M² are each independently selected from H, Na⁺, K⁺, Li⁺, N(R′)₄⁺; and x is an integer selected from 1-8.

As an option, the first functional group is capable of interacting with carbon black. Carbon black can have one or more types of surface functional groups such as, but not limited to, oxygen-containing groups such as carboxylic acid (and salts thereof), hydroxyls (e.g., phenols), esters or lactones, ketones, aldehydes, anhydrides, and benzoquinones. As another option, the second functional group is capable of interacting with the solid elastomer. Solid elastomers can be natural elastomers, synthetic elastomers, and blends thereof. For example, the solid elastomers can be selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof. As an option, the solid elastomer can be selected from natural rubber, styrene-butadiene rubber, and polybutadiene rubber. The solid elastomer can have olefin groups and/or may be functionalized with a number of groups.

As an option, the first functional group can be selected from —NR¹R² (e.g., —NH₂) and —S—SO₃M¹ and the second functional group can be selected from —S—SO₃M² and —CR³═CR⁴—CO₂M².

The linking agent can comprise more than two functional groups. With such linking agents, each additional functional group, e.g., a third, fourth, etc. functional group, can be selected from the list of first and second functional groups as disclosed herein. As an option, more than one type of linking agent can be used to prepare a composite.

The linking agent can further comprise at least one spacer between the first and second functional groups. For example, one or more spacers can be bonded to each other and ultimately to the first and second functional groups. As an option, the at least one spacer is selected from —(CH₂)ₙ—, —(CH₂)_{y}C(O)—, —C(R⁹)═C(R¹⁰)—, —C(O)—, —N(R⁹)—, and —C₆H₄—, wherein y is an integer selected from 1-10 and R⁹ and R¹⁰ are each independently selected from H and C¹-C⁶ alkyl.

Exemplary linking agents are selected from compounds of formula (1), formula (2), and formula (3),

H₂N—Ar—N(H)—C(O)—C(R⁶)═C(R⁷)—CO₂M² (1)

H₂N—(CH₂)ₙ—SSO₃M² (2)

M¹O₃S—S—(CH₂)n-S—SO₃M² (3).

M¹ and M² are as defined herein, R⁶ and R⁷ are independently selected from H and C₁-C₈ alkyl (e.g., independently selected from H and C₁-C₆ alkyl or independently selected from H and C₁-C₄ alkyl). As an option, M¹ and M² are each independently selected from H, Nat, and N(R′)₄⁺, e.g., from H and Na⁺, and R⁶ and R⁷ are the same, e.g., R⁶ and R⁷ are each H. An example of a linking agent of formula (1) is sodium (2Z)-4-[(4-aminophenyl)amino]-4-oxo-2-butenoate, commercially available as Sumilink® 200 coupling agent and an example of a linking agent of formula (2) is S-(3-aminopropyl)thiosulfuric acid, commercially available as Sumilink® 100 coupling agent (Sumitomo). An example of a linking agent of formula (3) is commercially available as Duralink™ HTS tire additive (Eastman Chemical Co.). Other linking agents include cystamine and thiourea.

As an option, the uncured composite is a product of mixing at least a filler, an elastomer (or latex), and the at least one linking agent, e.g., during a first stage mixing method with the filler and elastomer (or latex), or in combination with a coagulum resulting from mixing a filler slurry and latex, or during compounding of a composite (productive or nonproductive) and/or further processing of an uncured composite. Examples of composites and methods of forming such composites containing linking agents are disclosed in U.S. Pat. Nos. 9,365,497, 10,208,137, 10,343,455, 10,793,702, 10,889,658, and U.S. Publ. Nos. 2018/0105654, 2019/0218350, 2019/0144634, 2019/0241723, and PCT Appl. No. PCT/US21/62433, filed Dec. 8, 2021, the disclosures of which are incorporated by reference herein. For example, the uncured composite is the product of known dry mixing processes, e.g., mixing filler, elastomer, and the at least one linking agent. As another example, the uncured composite is a product of mixing (in one or more mixing steps) the at least the solid elastomer, the wet filler, and the linking agent to form a mixture, and removing at least a portion of the liquid from the mixture by evaporation, or as described in PCT Appl. No. PCT/US21/62433, filed Dec. 8, 2021, the disclosures of which are incorporated by reference herein. As another example, the uncured composite is prepared by mixing a wet filler and a solid elastomer, as described in PCT Publication No. WO 2020/247663 A1, the disclosure of which is incorporated by reference herein, and further combined with the at least one linking agent as described in PCT Appl. No. PCT/US21/62433, filed Dec. 8, 2021, the disclosure of which is incorporated by reference herein. The amount of linking agent added to the composite, coagulum, or compound, or charged to the mixer (or by any of the methods disclosed herein) can range from 10 phr or less, e.g., 6 phr or less, 5 phr or less, 4 phr or less, 3 phr or less, or 2 phr or less, e.g., an amount ranging from 0.1 phr to 10 phr, from 0.1 phr to 8 phr, from 0.1 phr to 6 phr, from 0.1 phr to 5 phr, from 0.1 phr to 4 phr, from 0.1 phr to 3 phr, or from 0.1 phr to 2 phr, or other amounts as disclosed in PCT Appl. No. PCT/US21/62433, filed Dec. 8, 2021, the disclosure of which is incorporated by reference herein.

The elastomer composite can be stored in any form, e.g., sheets, blocks, or smaller pieces such as frites, e.g., bales of such smaller pieces such as a bale of frites. Small pieces of composite can be formed by using a granulator, as disclosed in U.S. Pat. No. 7,341,142, the disclosure of which is incorporated by reference herein. The form of the elastomer composite can affect the amount of oxygen present in the container. For example, a bale of frites randomly arranged can have a porosity of at least 25%.

When mixing elastomer with filler, some degradation of the rubber can occur. In certain instances, elastomer composites having dispersed fillers such as carbon black, silica, silicon-treated carbon black, or any fillers disclosed herein, may benefit from the presently disclosed containers, packages and/or storing methods. Filler distribution and dispersion in the elastomer network can be indicated by a “dispersion state” or “state of dispersion” or macrodispersion. As an option, macrodispersion can be indicated by a “d₉₀” particle size distribution in which particle sizes are determined by measuring % area contribution from particles>2 μm. Area contribution from particles can be reported for an imaging area, and total imaging area (μm²) of an image can be determined from the number of pixels and the image resolution. An image can have dimensions of width and height, each reported in number of pixels, and the corresponding area can be reported as (pixels)². For an area, resolution can be reported as (μm/pixel)². The imaging area is the product of:

(area)*(resolution).

As an option, d₉₀ is the area-equivalent diameter (μm) of filler particles in the composite, where d₉₀ is no more than 100 μm, e.g., no more than 90 μm, no more than 80 μm, no more than 70 μm, no more than 60 μm, no more than 50 μm, or no more than 40 μm, no more than 30 μm, no more than 20 μm, or no more than 10 μm.

As an option, the composite has a G′(10%) of at least 50 kPa, e.g., at least 100 kPa, or at least 200 kPa, e.g., the G′(10%) ranges from 50 to 1,500 kPa, from 100 to 1,500 kPa, from 200 to 1,500 kPa, from 100 to 1,000 kPa, or from 200 to 1,000 kPa, wherein G′(10%) is a dynamic storage modulus measured at 10% strain amplitude.

### EXAMPLES

The following tests were used to obtain performance data on each of the vulcanizates:
Tensile stress at 100% elongation (M100) and tensile stress at 300% elongation (M300) were evaluated by ASTM D412 (Test Method A, Die C) at 23° C., 50% relative humidity and at crosshead speed of 500 mm/min. Extensometers were used to measure tensile strain. The ratio of M300/M100 is referred to as tensile stress ratio (or modulus ratio).
Max tan δ was measured with an ARES-G2 or ARES 2K rheometer (Manufacturer: TA Instruments) using 8 mm diameter parallel plate geometry in torsional mode. The vulcanizate specimen diameter size was 8 mm diameter and about 2 mm in thickness. The rheometer was operated at a constant temperature of 60° C. and at constant frequency of 10 Hz. Strain sweeps were run from 0.1-63% strain amplitude. Measurements were taken at ten points per decade and the maximum measured tan δ (“max tan δ”) was reported, also referred to as “tan δ” unless specified otherwise. The Payne ratio of the compound was calculated from the ratio of dynamic storage modulus G′ at 0.1% strain to G′ at 50% strain, i.e., G′(0.1%)/G′(50%).
Rheological properties were determined with a rubber process analyzer (RPA; D-RPA 3000, MonTech Rubber Testing Solutions). A sample (5 g) was cut from rubber composites. Temperature was set at 100° C. and 1 Hz shear frequency was used throughout the test procedure. The test program was static for 5 min, then 10 cycles of shearing at 50% strain followed by 30 min at 0.3% strain, and finally a strain sweep from 0.3-51.5% strain. The Payne ratio of the composite was calculated from the ratio of dynamic storage modulus G′ at 0.3% strain to G′ at 51.5% strain, i.e., G′(0.3%)/G′(51.5).

### Example 1

This Example describes the results of storing different portions of the same elastomer composite under air, nitrogen, and vacuum where the elastomer composite was prepared by a liquid mixing process.

The composite was prepared by the liquid process of U.S. Pat. No. 8,586,651, Example 2, except as noted here. The elastomer latex (diluted and de-sludged MVL Field Latex) had a dry rubber content of 28 wt. % and the filler slurry contained 13-14 wt. % carbon black (Propel® E7 carbon black, “E7”; Cabot Corporation). Flow rates were adjusted to yield a final carbon black loading of 55 phr at the desired production rate. The average carbon black loading level of the resulting composite was 55 phr. The dewatered composite was masticated, mixed with 2 phr antioxidant (6PPD) and dried in a continuous mixer (Farrel Unimix Continuous Mixer (FCM), equipped with two #15 rotors; operated at 190-320 rpm, Farrel Corporation, Ansonia, CT) and further masticated, cooled and dried on an open mill.

The composite was formed into frites by processing a 90 mm strip through a granulator to form smaller pieces having a dimension of approximately 80 mm length by 8 mm width by 8 mm thickness. Methods of cutting strips with a granulator are disclosed in U.S. Pat. No. 7,341,142, the disclosure of which is incorporated by reference herein. The frites were then split into a number of samples that were stored under a set of conditions listed in Table 3.

After storage, all elastomer composites were compounded in a 300 mL C. W. Brabender internal mixer fitted with cam blades according to the formulation shown in Table 1 and the protocol shown in Table 2. Accelerator BBTS was (N-tert-butyl-2 benzothiazole sulfenamide), from Akrochem, Akron, Ohio Compounding conditions were: starting temperature=40° C.; rotor speed=60 rpm; fill factor=60%.

TABLE 1

| Formulation | (phr) |
|---|---|
| For Elastomer Composite | |
| NR Latex | 100 |
| CB E7 | 55 |
| 6PPD | 2 |
| For Compounding | |
| Elastomer composite | 157 |
| Zinc Oxide | 4 |
| Stearic Acid | 2 |
| 6PPD | 0.5 |
| Accelerator BBTS | 0.8 |
| Sulfur | 1.2 |

TABLE 2

| Time (s) | Description |
|---|---|
| 0 | add elastomer composite, start timer |
| 120 | add zinc oxide, 6PPD and stearic acid |
| 240 | add BBTS and sulfur |
| 300 | dump - check compound temperature and weight |

The compounds were then sheeted on a 2-roll mill operated at 50° C. at a speed of 10.5 m/min, followed by four (rolled endwise) passes through the mill with a nip gap of about 5 mm. The samples were cured in a heated press at 150° C. for 30 min.

Table 3 outlines the storage conditions of each composite (prior to compounding) and properties of the composite and resulting compounds (vulcanizates). “Time” in Table 3 refers to the number of days the sample was stored under the stated conditions.

In Table 3, “Atm” refers to whether the sample was stored in air, nitrogen (“N2”), or vacuum (“vac”). For samples stored in vacuum, the composites were placed in metallized bags (Marvelseal® 360 barrier film from Berry Global, Inc., a biaxially oriented Nylon/PE/aluminum foil/PE/LLDPE (sealant layer); total thickness of film=132 μm; oxygen transmission rate=0.009 cm³/(m²·day·atm) at 0% RH, 73° F.). Within three hours of production of the composite, the bags were flushed with nitrogen, evacuated to achieve a pressure of 84.7 kPa, and sealed. For samples stored under nitrogen, within three hours of production, the composites were placed in metallized bags, evacuated, flushed with nitrogen, and sealed at ambient pressure within three hours of production. The gas flushing and evacuating steps were performed with an AmeriVacs AVN retractable nozzle vacuum heat-sealer.

In Table 3, “Temp” refers to storage temperature of the composite. “60° C.” refers to samples stored at 60° C. (50% relative humidity) which was achieved by placing the samples in an oven (including samples stored in a bag). After storing for the designated time period at 60° C., the samples were allowed to equilibrate to room temperature overnight prior to compounding. “20° C.” refers to samples stored in air-conditioned rooms with temperature control at 20±3° C.

Properties of reference composite were measured prior to sealing (Day=0, i.e., no storage). The values in Table 3 reported for samples stored under air-conditioning are average values obtained from six samples. The values reported for samples stored at 60° C. are average values obtained from four samples. All properties reported are for vulcanizates except where indicated for composites indicated by “(C)”.

TABLE 3

| | | | Payne | G′0.3%, | G′51.5%, | max | | | | | | |
|---|---|---|---|---|---|---|---|---|---|---|---|---|
| Time | | | Ratio | kPa | kPa | tan | M100 | M300 | M300/ | Payne | G′0.1%, | G′50%, |
| (days) | Atm | Temp | (C) | (C) | (C) | δ | (MPa) | (MPa) | M100 | Ratio | MPa | MPa, |
| 0 | Air | 20° C. | 2.9 | 999 | 341 | 0.136 | 3.0 | 19.1 | 6.3 | 3.2 | 4.5 | 1.4 |
| 60 | Air | 20° C. | 3.3 | 1107 | 337 | 0.137 | 3.1 | 18.6 | 6.0 | 3.4 | 5.3 | 1.6 |
| 90 | Air | 20° C. | 3.6 | 1234 | 345 | 0.142 | 3.1 | 18.7 | 6.0 | 3.4 | 5.3 | 1.6 |
| 60 | N2 | 20° C. | 2.9 | 1046 | 363 | 0.126 | 2.9 | 18.8 | 6.5 | 2.9 | 4.3 | 1.5 |
| 90 | N2 | 20° C. | 2.8 | 1029 | 369 | 0.128 | 2.7 | 17.7 | 6.4 | 2.9 | 4.0 | 1.4 |
| 60 | vac | 20° C. | 2.9 | 1056 | 368 | 0.121 | 2.9 | 18.7 | 6.4 | 2.8 | 4.4 | 1.5 |
| 90 | vac | 20° C. | 2.9 | 1050 | 361 | 0.124 | 2.9 | 18.6 | 6.4 | 2.8 | 4.0 | 1.4 |
| 2 | Air | 60° C. | 3.1 | 1040 | 339 | 0.148 | 2.7 | 18.5 | 6.7 | 3.3 | 4.3 | 1.3 |
| 5 | Air | 60° C. | 3.1 | 1046 | 337 | 0.152 | 2.9 | 18.3 | 6.3 | 3.5 | 4.7 | 1.3 |
| 7 | Air | 60° C. | 3.3 | 1115 | 333 | 0.154 | 2.9 | 18.6 | 6.4 | 3.5 | 4.6 | 1.3 |
| 14 | Air | 60° C. | 3.6 | 1144 | 318 | 0.163 | 2.9 | 18.5 | 6.4 | 3.7 | 4.6 | 1.2 |
| 21 | Air | 60° C. | 3.9 | 1219 | 316 | 0.159 | 3.1 | 18.7 | 6.1 | 3.8 | 5.5 | 1.5 |
| 2 | N2 | 60° C. | 2.8 | 1057 | 372 | 0.132 | 2.9 | 19.5 | 6.7 | 3.0 | 4.1 | 1.4 |
| 5 | N2 | 60° C. | 2.7 | 1033 | 377 | 0.126 | 2.8 | 18.3 | 6.6 | 2.8 | 3.7 | 1.3 |
| 7 | N2 | 60° C. | 2.8 | 1070 | 381 | 0.13 | 2.9 | 19.4 | 6.7 | 2.9 | 3.8 | 1.3 |
| 14 | N2 | 60° C. | 2.8 | 1077 | 390 | 0.127 | 2.9 | 19.8 | 6.9 | 2.8 | 3.7 | 1.3 |
| 21 | N2 | 60° C. | 2.9 | 1084 | 379 | 0.122 | 2.8 | 19.3 | 6.9 | 2.7 | 3.4 | 1.2 |
| 2 | vac | 60° C. | 2.8 | 1035 | 364 | 0.132 | 2.8 | 19.1 | 6.8 | 2.9 | 4.0 | 1.3 |
| 5 | vac | 60° C. | 2.7 | 1043 | 382 | 0.127 | 2.8 | 18.4 | 6.7 | 2.8 | 3.7 | 1.3 |
| 7 | vac | 60° C. | 2.7 | 1025 | 377 | 0.128 | 2.7 | 18.8 | 6.9 | 2.9 | 3.8 | 1.3 |
| 14 | vac | 60° C. | 2.7 | 1018 | 375 | 0.122 | 2.9 | 19.6 | 6.9 | 2.6 | 3.2 | 1.2 |
| 21 | vac | 60° C. | 2.8 | 1080 | 385 | 0.121 | 2.8 | 19.4 | 7.0 | 2.7 | 3.5 | 1.3 |

The data of Table 3 provide properties of the composite, which is stored, and the resulting compound, i.e., the vulcanizate produced from the stored composite. With regards to composite properties, Payne ratio, is beneficially decreased for the nitrogen and vacuum-stored samples compared to the samples stored in air over a 90-day period. With regards to compound properties, it can be seen that under all temperature conditions, the nitrogen and vacuum-packed samples show retention or decrease in maximum tan δ values and Payne Ratio. In contrast, maximum tan δ increases for all samples stored in air (with standard oxygen content of 21%) over the 90-day period. This effect is pronounced when storing at 60° C. as seen by the increase in maximum tan δ for samples stored in air versus the corresponding decrease for samples stored under nitrogen or vacuum. The present composites and corresponding compounds provide a very unexpected hysteresis improvement compared to those samples stored in air (i.e., not stored in an oxygen barrier container).

### Example 2

This Example describes the results of storing different portions of the same elastomer composite under air, nitrogen, and vacuum where the composite was prepared by dry mixing processes.

All samples were prepared with ASTM grade N234 carbon black, provided as VULCAN® 7H carbon black (“V7H”; Cabot Corporation). The elastomer used was standard grade RSS3 natural rubber (Hokson Rubber, Malaysia). Technical descriptions of this natural rubber are widely available, such as in Rubber World Magazine's Blue Book published by Lippincott and Peto, Inc. (Akron, Ohio, USA).

Mixing of composite was performed in one stage with a BR-1600 Banbury® mixer (“BR1600”; Manufacturer: Farrel). The resulting composites were compounded in a single stage in a 439 mL C. W. Brabender internal mixer. Table 4 shows the formulations for mixing and compounding. The wax beads were Akrowax™ 5031 wax beads from Akrochem, Akron, Ohio.

TABLE 4

| | |
|---|---|
| Formulation | (phr) |

For Elastomer Composite

| | |
|---|---|
| NR | 100 |
| CB V7H | 50 |
| 6PPD | 2 |

For Compounding

| | |
|---|---|
| Elastomer Composite | 152 |
| Zinc Oxide | 3 |
| Stearic Acid | 2 |
| 6PPD | 0.5 |
| Antioxidant DQ Pellets | 1.5 |
| wax beads | 1.5 |
| Accelerator BBTS | 1.4 |
| Sulfur | 1.2 |

The mixing protocol is shown in Table 5, where mixing was performed under the following conditions: temperature control unit (TCU) temperature=50° C.; rotor speed=80 rpm, fill factor=60%, and ram pressure=2.8 bar.

TABLE 5

| | |
|---|---|
| Step Time or Temperature | Step Description |

| | | |
|---|---|---|
| 0 | s | Add NR |
| 60 | s | Add ⅔ Filler |
| 120 | s | Sweep/Add Remaining Filler |
| 150 | s | Sweep |
| 140° | C. | Add 6PPD |
| | | Sweep/Scrape |
| 160° | C. | Dump |

The resulting composites were sheeted on a roll mill operated at 50° C. and about 37 rpm, followed by six end-roll passes with a nip gap about 5 mm. The composite sheets were split into a number of samples for storage in either air or under nitrogen. For the samples in a nitrogen environment, elastomer composites were placed in a nitrogen-purged glove box (oxygen concentration less than 2%). All samples were stored in an air conditioned (20° C.) atmosphere.

Compounding protocols are shown in Table 6, where compounding was performed under the following conditions: TCU temperature=40° C., rotor speed=60 rpm, fill factor=60%.

TABLE 6

| Time (s) | Description |
|---|---|
| 0 | Add composite slowly (60 s to ingest + 60 s mastication) |
| 120 | Add Zinc Oxide, Stearic Acid, and 6PPD |
| 240 | Sweep/Scrape - Add BBTS and sulfur (preblended) |
| 300 | Dump |

The resulting compounds were sheeted on a 2-roll mill operated at 50° C. and 37 rpm, followed by four passes (rolled endwise) through the mill with a nip gap about 5 mm. The samples were cured in a heated press at 150° C. for 30 min.

Compound and composite properties are shown in Table 7 where “Atm” is as defined in Example 1. Properties of reference composite was measured prior to sealing (Day=0, i.e., no storage).

TABLE 7

| | | | Payne | G′0.3%, | G′51.5%, | max | | | | | | |
|---|---|---|---|---|---|---|---|---|---|---|---|---|
| Time | | | Ratio | (kPa) | (kPa) | tan | M100 | M300 | M300/ | Payne | G′0.1% | G′50% |
| (days) | Atm | Temp | (C) | (C) | (C) | δ | (MPa) | (MPa) | M100 | Ratio | (MPa) | (MPa) |
| 0 | Air | 20° C. | 5.5 | 1597 | 287 | 0.205 | 3.2 | 17.2 | 5.4 | 5.2 | 7.6 | 1.5 |
| 30 | Air | 20° C. | 6.0 | 1636 | 272 | 0.217 | 3.3 | 17.1 | 5.3 | 5.7 | 8.2 | 1.5 |
| 90 | Air | 20° C. | 6.3 | 1719 | 276 | 0.225 | 3.0 | 15.8 | 5.2 | 5.9 | 7.9 | 1.4 |
| 180 | Air | 20° C. | 6.3 | 1701 | 270 | 0.228 | 3.3 | 16.8 | 5.2 | 6.4 | 10.6 | 1.7 |
| 30 | N2 | 20° C. | 4.8 | 1510 | 316 | 0.182 | 3.2 | 17.6 | 5.6 | 4.3 | 5.6 | 1.3 |
| 90 | N2 | 20° C. | 4.6 | 1519 | 331 | 0.192 | 3.0 | 16.8 | 5.6 | 4.8 | 6.2 | 1.3 |
| 180 | N2 | 20° C. | 4.3 | 1458 | 345 | 0.187 | 3.2 | 17.8 | 5.6 | 4.5 | 6.9 | 1.5 |

From the data of Table 7, it can be seen that composites stored under nitrogen show lower Payne Ratio values compared to the samples stored in air for the same amount of time. For the compound (vulcanizate) properties, the maximum tan δ values for the samples stored in air increase over the 180 day course. In contrast, the maximum tan δ values for the samples stored under nitrogen were noticeably lower compared to the values of the samples stored in air. The samples stored under nitrogen also had a slightly higher tensile stress ratio (M300/M100) and lower in Payne ratio compared to the samples stored in air (i.e., not stored in an oxygen barrier container).

### Example 3

This Example describes the results of storing different portions of the same elastomer composite under air or nitrogen where the composite was prepared by mixing a wet filler with a solid elastomer. The composite was stored as sheets.

All samples were prepared with ASTM grade N234 carbon black, provided as VULCAN® 7H carbon black (“V7H”; Cabot Corporation). The elastomer used was standard grade RSS3 natural rubber (Sri Trang Agro-Industry Public Company Limited, Thailand). Wet carbon black was prepared by milling dry carbon black pellets with an 8″ model MicroJet mill to generate fluffy carbon black particles having a 99.0% particle size diameter less than 10 microns. This fluffy carbon black was then wet pelletized in a pin pelletizer. The resulting wet carbon black (rewetted carbon black) had a moisture content of 57%.

Composites were prepared via a two-stage mixing process followed by two-stage compounding to generate the vulcanizates. The formulations are shown in Table 8; the carbon black loading is reported on a dry basis.

TABLE 8
Formulation (phr)
For Elastomer Composite

| | |
|---|---|
| RSS3 | 100 |
| CB Vulcan ® 7H | 50 |
| 6PPD | 2 |

Compounding-1

| | |
|---|---|
| Elastomer Composite | 152 |
| Zinc Oxide | 3 |
| Stearic Acid Rubber Grade | 2 |
| 6PPD | 0.5 |
| Antioxidant DQ Pellets | 1.5 |
| wax beads | 1.5 |

Compounding-2

| | |
|---|---|
| Accelerator BBTS Powder | 1.4 |
| Sulfur | 1.2 |

The first stage of composite mixing was conducted in a Kobelco BB-72 tangential mixer fitted with 4WN rotors (66 L capacity), at a fill factor of 66%. The mixing chamber, rotors and ram were heated with a TCU set at 75° C. The ram pressure was 15.5 MPa. After the first stage mix, the composite was processed in a Kobelco TSR-125 twin-screw discharge extruder fitted with stationary knives (Kobelco Kobe Steel Group).

The first stage mixing protocol is shown in Table 9. The resulting batch times were 9.2-9.4 minutes. The first stage composite had a probe temperature range of 123-131° C. and a moisture content of 4%.

TABLE 9

| Mixer RPM | Description |
|---|---|
| 45 | Add rubber to mixer in 20 s |
| 45 | Masticate rubber until 110° C. |
| 60 | Add ½ filler in 20 s |
| 80 | Mix until 130° C. |
| 60 | Add ¼ filler in 20 s |
| 80 | Mix until 130° C. |
| 60 | Add ¼ filler in 20 s |
| 80 | Mix until 168° C. |
| 60 | Add 6PPD in 20 s |
| 80 | Mix until 175° C. and discharge batch |

The second stage mixing protocol is shown in Table 10. Second stage mixing of the composite was conducted on a Kobelco BB-16 tangential mixer, fitted with 6WI rotors (14 L capacity), at a fill factor of 40% (Kobelco Kobe Steel Group). The mixing chamber and rotors were maintained at constant temperature using a TCU set at 50° C. The mixing was performed with the ram raised to its highest position, so it did not apply any pressure to the contents of the mixer. The delay between first and second stages of composite mixing was no more than 2 h. After initial mastication, second stage composite mixing was performed under PID control (proportional integral differential), which allows automated control of the batch temperature via a feedback loop. A thermocouple inserted through the mixer drop door measures the batch temperature, which is transmitted to a PID controller. The output of the controller is used to control the speed of the mixer rotors. The second stage composite mixing protocol is shown in Table 10. The second stage composite had a probe temperature range of 133-140° C. and a moisture content of <1%.

TABLE 10

| Mixer rpm | Description |
|---|---|
| 35 | Add composite to mixer |
| 35 | Masticate with ram raised for 90 s |
| 35-50 | Masticate with ram raised for 390 s. Batch temperature |
| | automatically controlled via PID control, using a set point of |
| | 135° C. |

After the second stage mix, the composite was processed in a TSR-125 twin-screw discharger extruder fitted with roller die (Kobelco Kobe Steel Group) to create sheets. After 27 days at ambient conditions, the composites were then stored as sheets under the conditions outlined in Table 13. Storage temperatures were 20° C. (air conditioned) and samples were stored in air or in a nitrogen-purged glove box (“N2”) (oxygen concentration less than 2%).

Two-stage compounding was performed with the BR1600 mixer under the following conditions: TCU temperature=50° C. (1^{st} and 2^{nd} stage); rotor speed=80 rpm (1^{st} stage) or 60 rpm (2^{nd} stage); Fill Factor=68% (1^{st} stage) or 65% (2^{nd} stage); ram pressure=2.8 bar (1^{st} and 2^{nd} stage). 1^{st} and 2^{nd} stage compounding protocols are shown in Tables 11 and 12, respectively.

TABLE 11

| Time (s) | Description Stage 1 Compounding |
|---|---|
| 0 | Add composite |
| 30 | Add “Compounding-1” formulation |
| 90 | Scrape/Sweep |
| 150 | Dump at 150 s, adjust RPM until temperature <125° C. |

TABLE 12

| Time (s) | Description Stage 2 Compounding |
|---|---|
| 0 | Add ½ stage 1 composite/“compounding-2” formulation/remaining stage 1 composite |
| 30 | Sweep |
| 90 | Dump, adjust RPM until temperature <115° C. |

After each compounding stage, the compounds were sheeted on a 2-roll mill operated at 50° C. and about 37 rpm, followed by six end roll pass-through the roll mill with a nip gap about 5 mm. The stage 2 samples were cured in a heated press (150° C., 2500 lbs) for a time (30 min.). Vulcanizate properties are shown in Table 13. Properties of reference composite was measured prior to sealing (Day=0, i.e., no storage)

TABLE 13

| | | | max | | | | | | |
|---|---|---|---|---|---|---|---|---|---|
| Time | | | tan | M100 | M300 | M300/ | Payne | G′0.1%, | G′50% |
| (days) | Atm | Temp | δ | (MPa) | (MPa) | M100 | Ratio | (MPa) | (MPa) |
| 0 | Air | 20° C. | 0.176 | 2.9 | 16.6 | 5.8 | 4.3 | 5.3 | 1.3 |
| 90 | Air | 20° C. | 0.186 | 2.8 | 14.7 | 5.3 | 4.3 | 6.2 | 1.5 |
| 90 | N2 | 20° C. | 0.166 | 2.8 | 15.5 | 5.6 | 3.8 | 5.2 | 1.4 |
| 180 | N2 | 20° C. | 0.151 | 2.9 | 16.1 | 5.5 | 3.5 | 5.8 | 1.7 |

From the data of Table 13, it can be seen that the maximum tan δ values for the sheets stored in air at 20° C. are retained or increase over the 180 day course. In contrast the samples stored under nitrogen have noticeably decreased maximum tan δ values after the 180 day storage period. In addition, the samples stored in nitrogen show smaller decreases in tensile stress than the samples stored at 20° C. in air. Moreover, only the samples stored under nitrogen showed decreased Payne ratio values.

### Example 4

This Example describes the results of storing different portions of the same elastomer composite as sheets under air or vacuum where the composite was prepared by mixing a wet filler with a solid elastomer and a linking agent, and an evaluation of the compound properties prepared from the composite.

All samples were prepared with ASTM grade N234 carbon black, provided as VULCAN® 7H carbon black (“V7H”; Cabot Corporation). The wet carbon black pellets had a moisture content of 56% and were prepared by milling with an 8″ model MicroJet mill to generate fluffy carbon black particles having a 99.5% particle size diameter less than 10 μm. This fluffy carbon black was then wetted with the pin pelletizer to regenerate the wetted pellets. The elastomer used was standard grade RSS3 natural rubber (Von Bundit Co. Ltd., Thailand). Technical descriptions of this natural rubber are widely available, such as in Rubber World Magazine's Blue Book published by Lippincott and Peto, Inc. (Akron, Ohio, USA). The linking agent used was sodium (2Z)-4-[(4-aminophenyl)amino]-4-oxo-2-butenoate, commercially available as Sumilink® 200 coupling agent (“S200”; Sumitomo Chemical).

Composites were prepared via a two-stage mixing process followed by single-stage compounding. The formulations are shown in Table 8; the carbon black loading is reported on a dry basis. The formulations used are shown in Table 14. Carbon black loading was targeted on a dry basis.

TABLE 14

| Formulations | (phr) |
|---|---|
| Stage 1 Formulation | |
| RSS3 | 100 |
| V7H wet | 50 |
| S200 | 2 |
| 6PPD | 2 |
| For Compounding | |
| TMQ | 1.5 |
| zinc oxide | 3 |
| stearic acid | 2 |
| wax beads | 1.5 |
| 6PPD | 0.5 |
| BBTS | 1.4 |
| Sulfur | 1.2 |

The first stage of the two-stage mixing protocol is outlined in Table 15. Time intervals refer to the step time. First stage mixing was conducted on the BB-16 mixer fitted with 4WN rotors (16.2 L capacity) under the following conditions: TCU temperature=90° C., fill factor=66%, ram pressure=112 barg.

TABLE 15

| Time or | | rotor speed | |
|---|---|---|---|
| Temp | | (rpm) | Description |
| 20 | s | 50 | feed rubber to mixer |
| 110° | C. | 60 | masticate rubber until 110° C. |
| 20 | s | 60 | add 1st filler addition (75%) |
| 120 s or | | 85 | mix until earliest of 120 secs and 130 C. |
| 130° C. | | | |
| 20 | s | 60 | add S200 followed by 2^{nd} |
| | | | filler addition |
| 20 | s | 60 | mix at 60 rpm for 20 secs, to allow |
| | | | hydraulic system to reach |
| | | | pressure |
| 155° | C. | 85 | mix until 6PPD addition temperature (155° C.) |
| 20 | s | 60 | Add 6PPD. |
| 160° | C. | 85 | mix until dump temperature (160° C.) |
| 30 | s | 50 | discharge after 30 s |

The moisture content of the composite after 1^{st} stage mixing was 4.96% (mixing time=7 min 20 s, probe temperature=125° C.). After the first stage mix, the composite was processed with a TSR-125 twin-screw discharge extruder fitted with stationary knives (Kobelco Kobe Steel Group).

The second stage mixing protocol is shown in Table 16 and mixing was conducted on the BB-16 mixer fitted with 6WI rotors (14.4 L capacity) under the following conditions: TCU temperature=65° C., fill factor=35%, ram pressure=112 barg. After an initial mastication, mixing was performed under PID temperature control with the ram raised to its highest position, as described in Example 3.

TABLE 16

| Time or | Rotor speed | |
|---|---|---|
| Temp | (rpm) | Description |
| 20 s | 35 | Add composite to the mixer |
| 90 s | 35 | masticate with ram raised for 90 s |
| 35-54 | Variable | masticate under PID temperature control |
| | | with ram raised; batch |
| | | temperature automatically controlled with |
| | | a set point of 135° C. |
| 30 | Discharge | discharge mixer & close drop door after 30 s |

After the second stage mix, the composite was processed in a TSR-125 twin-screw discharger extruder fitted with roller die (Kobelco Kobe Steel Group) to create sheets. The resulting sheets were cooled under ambient air for 27 days.

The composites were then stored as sheets in air or vacuum for a period of 90 days at 20° C. For samples stored under vacuum, the composites were placed in metallized bags (Marvelseal® 360 barrier film) and subjected to gas flushing and then evacuation with an AmeriVacs AVN retractable nozzle vacuum heatsealer.

After the storage period, vulcanizates were formed by compounding the stored composites with the stage 3 formulation of Table 14 in a 439 mL C. W. Brabender prep mixer fitted with CAM blades according to the protocol shown in Table 17. Accelerator BBTS was (N-tert-butyl-2 benzothiazole sulfenamide), from Akrochem, Akron, Ohio. Compounding conditions were: starting temperature=40° C.; rotor speed=60 rpm; fill factor=60%.

TABLE 17

| Time (s) | Description Stage 1 Compounding |
|---|---|
| 0 | Add composite |
| 120 | Add Zinc Oxide, stearic acid and 6PPD |
| 240 | Scrape/Sweep - Add BBTS & Sulfur |
| 300 | Dump |

After the compounding stage, the composites were sheeted on a 2-roll mill operated at 50° C. and about 37 rpm, followed by six pass-throughs with a nip gap about 5 mm. The final compounds were sheeted to 2.4 mm thickness on a 2-roll mill operated at 60° C. The final compounds were cured in a heated press at 150° C. for 30 min.

Properties of the vulcanizates prepared from three samples each of the 90 day-aged composite samples are shown in Table 18. “Atm” refers to the atmosphere the sample was stored, either in air or under vacuum.

TABLE 18

| | | Avg. | | | | | | |
|---|---|---|---|---|---|---|---|---|
| Time | | max | Payne | G′@0.1%, | G′@50% | M100 | M300 | M300/ |
| (days) | Atm | tan δ | Ratio | (MPa) | (MPa) | (MPa) | (MPa) | M100 |
| 1 | Air | 0.157 | 3.88 | 5.61 | 1.45 | 3.3 | 18.8 | 5.73 |
| 1 | Air | 0.153 | 3.94 | 5.92 | 1.50 | 3.3 | 18.8 | 5.69 |
| 1 | Air | 0.152 | 3.82 | 5.73 | 1.50 | 3.0 | 17.6 | 5.82 |
| 90 | Air | 0.152 | 3.66 | 4.65 | 1.27 | 3.3 | 18.0 | 5.45 |
| 90 | Air | 0.145 | 3.58 | 4.61 | 1.29 | 3.1 | 17.7 | 5.71 |
| 90 | Air | 0.148 | 3.69 | 4.87 | 1.32 | 3.3 | 18.7 | 5.67 |
| 90 | Vacuum | 0.134 | 3.19 | 4.12 | 1.29 | 3.2 | 18.0 | 5.63 |
| 90 | Vacuum | 0.136 | 3.42 | 4.63 | 1.35 | 3.5 | 20.2 | 5.77 |
| 90 | Vacuum | 0.132 | 3.20 | 4.13 | 1.29 | 3.2 | 19.1 | 5.97 |

From the data of Table 5, it can be seen that the maximum tan ô values for the sheets stored in vacuum at 20° C. have noticeably decreased maximum tan δ values after the 90 day storage period. Moreover, the sheets stored under vacuum showed decreased Payne ratio values.

### Example 5

This Example demonstrates the result of storing different portions of the same elastomer composite in packages having varying OTR values ranging from 0.527 cm³/m²/24 hr at 0% relative humidity and 73° F. to 1160 cm³/m²/24 hr at 0% relative humidity and 73° F.

Table 19 below lists the properties of the packages tested, including wall structure, OTR (at 0% relative humidity and 73° F.), and wall thickness. Packages A through D are flexible, transparent bags having dimensions of 12 in. (L)×12 in. (W) (volume of 3,865 cm³), purchased from ILC Dover, Inc. Reported OTR values were measured according to ASTM D3985 at 73° F., 0% RH.

TABLE 19

| | | Wall | |
|---|---|---|---|
| | Wall | thickness | OTR |
| Package | materials | (μm) | (cc/m²/24 hr) |
| A | PE/EVOH/PE/LLDPE | 81 | 0.527 |
| | (sealant) | | |
| B | LLDPE/Nylon/EVOH/Nylon/LLDPE | 76 | 2.33 |
| | (sealant) | | |
| C | EVA/Nylon/EVA | 51 | 233 |
| | (sealant) | | |
| D | LLDPE | 152 | 1160 |

The composites tested were prepared according to the Elastomer Composite formulation of Table 1, Example 1. The formulation for rubber composites was the same as Table 1, Example 1, without any compounding ingredients as no compounding was conducted for this example.

After 15 days storage in air, the composites (150 g, specific gravity of 1.112 g/cc) were stored in the packages and subjected to the conditions outlined in Table 20. Comparative (“Comp”) samples were stored in air. The remaining samples were stored in one of bags A, B, C, or D having respective OTR values listed in Table 19. The samples were stored under a unique combination of package atmosphere (“Package Atm”) and number of days stored in a 60° C. oven (“Day”). Under the “Package Atm” column, “Seal” refers to composites that were sealed in the package without any modification of the atmosphere. “Vac/N2” refers to composites that were stored after evacuating the package (containing the composite) to achieve a pressure of 84.7 kPa, followed by flushing the bags with nitrogen and sealing the package. The gas evacuating and flushing steps were performed with an AmeriVacs AVN retractable nozzle vacuum heatsealer. All samples were stored for 14 or 21 days in an oven at 60° C. to simulate long term storage under ambient conditions.

Oxygen content is reported as a concentration (%) of the total gas in the headspace in the bag and was determined by two separate methods. For transparent bags (bags A through D), the oxygen content in the headspace was measured non-invasively with an OpTech®-02, Model P oxygen headspace analyzer (“OpTech”), which uses optical fluorescence to measure sensors placed inside the clear package. Measurements were conducted on day 0 followed by measurements on day 14 and/or day 21 of storage at 60° C. after the bags were allowed to reach room temperature. For all bags, the oxygen content in the headspace was also measured by applying a resealable septum to the outside surface of a bag and puncturing the bag through the septum with a Dansensor® CheckPoint® 35, O2-Premium, Solid state sensor oxygen headspace analyzer (“CheckPoint”). Both types of oxygen analyzers are available from Ametek Mocon (Minnesota, USA).

TABLE 20

| | | | | | O₂ conc (%), | O₂ conc (%), | O₂ conc (%), |
|---|---|---|---|---|---|---|---|
| | OTR, | Package | | O₂ conc (%), | day 0 | day 14 | day 21 |
| Package | cm³/m²/24 hr | Atm | Day | (Checkpoint) | (OpTech) | (OpTech) | (OpTech) |
| Comp | N/A | Air | 0 | 21 | | | |
| Comp | N/A | Air | 14 | 21 | | | |
| Comp | N/A | Air | 21 | 21 | | | |
| A | 0.527 | Seal | 14 | 4 | 20.9 | 4.7 | |
| A | 0.527 | Seal | 21 | 3.8 | 19.3 | 7.2 | 3.9 |
| A | 0.527 | Vac/N2 | 14 | 2.8 | 1.9 | 2.5 | |
| B | 2.33 | Seal | 14 | 3.0 | 20.5 | 3.0 | |
| B | 2.33 | Seal | 21 | 6.6 | 20.0 | 9.6 | 6.9 |
| B | 2.33 | Vac/N2 | 14 | 3.6 | 1.4 | 3.6 | |
| C | 233 | Seal | 14 | 13.2 | 19.7 | 14.1 | |
| C | 233 | Seal | 21 | 13.2 | 20.8 | 12.0 | 12.5 |
| C | 233 | Vac/N2 | 14 | 8.5 | 1.4 | 8.9 | |
| C | 233 | Vac/N2 | 21 | 13.7 | 0.3 | 11.0 | 14.1 |
| D | 1160 | Seal | 14 | 20.2 | 19.7 | 20.5 | |
| D | 1160 | Seal | 21 | 20.2 | 19.4 | 20.0 | 19.5 |
| D | 1160 | Vac/N2 | 14 | 20.8 | 2.3 | 22.0 | |
| D | 1160 | Vac/N2 | 21 | 20.8 | 2.2 | 20.0 | 19.7 |

In Table 20, all comparative (“Comp”) samples have an oxygen headspace concentration of 21% as a result of being stored in air. All OTR values are reported at 0% RH and 73° F. All Checkpoint data points refer to measurements taken on the day indicated in the “Day” column. OpTech measurements were made on the days referred to in the respective “OpTech” columns. The oxygen content is expressed as the measured oxygen concentration.

From the data of Table 20, the general trend shows that the lower the OTR value, the lower the measured oxygen content in headspace, as indicated by both the CheckPoint and OpTech data.

The oxygen content in bags A and B (which have the lowest and second lowest OTR, respectively) was reduced or maintained over storage time whether sealed in air (“Seal”) or under modified atmosphere (“Vac/N2”).

The oxygen content of Bag C that was sealed in air also decreased over storage time but not to the extent of Bags A and B. The oxygen content of Bag D stored under air (“Seal”) did not decrease over time. When stored under modified atmosphere, it can be seen that the oxygen concentration increased for both Bags C and D over time and the final oxygen concentration values were noticeably higher than those of Bags A and B regardless of the storage method.

### Example 6

This Example demonstrates the viability of packages having high barrier wall properties for storing composites containing curing agents (green compounds).

Composites were prepared according to the Elastomer Composite formulation of Table 1, Example 1. Rubber compounds (green compounds) were prepared according to the compound formulation of Table 1, Example 1, and the protocol of Table 2, Example 1. The green compounds were then sheeted on a 2-roll mill operated at 50° C. at a rate of 10.5 m/min, followed by four (rolled endwise) passes through the mill with a nip gap of about 5 mm.

Different portions of the same elastomer composite, i.e., green compound (sheet prior to curing) were stored at 30° C. under the conditions outlined in Table 21. In Table 21, “Atm” refers to whether the sample was stored in air, or under vacuum (“vac”). “Day” refers to the number of days the sample was stored in the stated condition after compounding and before curing in the press. For samples stored in vacuum, the green compounds were placed in bags having the Marvelseal® 360 barrier film within three hours of compounding. The bags were flushed with nitrogen, evacuated to achieve a pressure of 84.7 kPa, and sealed. The gas flushing and evacuating steps were performed with an AmeriVacs AVN retractable nozzle vacuum heatsealer. Reference composites were measured prior to sealing (Day=0, i.e., no storage).

After storage, the compounds were cured in a heated press (150° C.) for 30 min. Vulcanizate properties are also shown in Table 21.

TABLE 21

| | | Avg. max | | | |
|---|---|---|---|---|---|
| Day | Atm. | tan δ | M100, MPa | M300, MPa | M300/M100 |
| 0 | Air | 0.136 | 3.11 | 18.97 | 6.1 |
| 0 | Air | 0.125 | 3.19 | 19.48 | 6.11 |
| 15 | Air | 0.139 | 2.86 | 17.83 | 6.23 |
| 15 | Air | 0.137 | 2.99 | 18.3 | 6.13 |
| 15 | Vacuum | 0.127 | 2.97 | 18.49 | 6.23 |
| 15 | Vacuum | 0.124 | 2.93 | 18.3 | 6.25 |
| 30 | Air | 0.141 | 2.95 | 17.96 | 6.09 |
| 30 | Air | 0.139 | 3.06 | 18.4 | 6.01 |
| 30 | Vacuum | 0.130 | 2.9 | 18.24 | 6.29 |
| 30 | Vacuum | 0.129 | 2.99 | 18.32 | 6.13 |
| 90 | Air | 0.155 | 2.95 | 17.82 | 6.04 |
| 90 | Air | 0.158 | 2.99 | 18.1 | 6.06 |
| 90 | Vacuum | 0.118 | 3.04 | 19.35 | 6.37 |
| 90 | Vacuum | 0.116 | 2.8 | 19.01 | 6.79 |

With regards to compound properties, it can be seen that under all temperature conditions, the green compounds stored under vacuum resulted in rubber compounds that showed retention or decrease in maximum tan δ values. Additionally, these rubber compounds also displayed an increase in tensile stress ratio (M300/M100). In contrast, maximum tan δ increased for all samples stored in air (with standard oxygen content of 21%) over the 90-day period.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A packaged elastomer composite, comprising:
a sealed package containing the composite in an atmosphere having a partial pressure of oxygen of less than 10 kPa, wherein the composite is uncured and comprises at least one elastomer and at least one filler, wherein:
the package comprises at least one wall surrounding the composite wherein the at least one wall comprises at least one oxygen barrier layer such that the package has an oxygen transmission rate of no more than 100 cm³/(m²·day·atm) at 23° C. and 0% relative humidity.

2. The packaged elastomer composite of claim 1, wherein the atmosphere has a partial pressure of oxygen of no more than 7 kPa.

3. (canceled)

4. The packaged elastomer composite of claim 1, wherein the atmosphere comprises at least 90% of at least one gas that is nonreactive with the elastomer composite.

5. The packaged elastomer composite of claim 4, wherein the at least one gas that is nonreactive with the elastomer composite is selected from nitrogen, argon, helium, xenon, and carbon dioxide.

6. The packaged elastomer composite of claim 1, wherein the at least one oxygen barrier layer comprises a material selected from polyamide, polyethylene, polyethylene terephthalate, polyethylene naphthalate, aluminum, poly(ethylene vinyl alcohol), poly(vinylidene chloride), polyacrylonitrile, and blends thereof and metallized layers thereof.

7. (canceled)

8. The packaged elastomer composite of claim 1, wherein the at least one oxygen barrier layer comprises a metallized layer or a metal layer.

9. (canceled)

10. The packaged elastomer composite of claim 1, wherein the at least one oxygen barrier layer comprises a material selected from metals, metal alloys, ceramics carbon-based nanomaterials, and melamine-based materials.

11-14. (canceled)

15. The packaged elastomer composite of claim 1, wherein the interior of the package has a volume of at least 10 L.

16. (canceled)

17. The packaged elastomer composite of claim 1, wherein the composite comprises an antidegradant present in an amount of at least 0.5 phr.

18-21. (canceled)

22. The packaged elastomer composite of claim 1, wherein the package further contains at least one oxygen scavenger.

23-25. (canceled)

26. The packaged elastomer composite of claim 1, wherein the at least one filler is selected from carbonaceous materials, carbon black, silica, bio-based fillers, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, carbon nanostructures, reclaimed carbon, or combinations thereof, and coated and chemically treated materials thereof.

27. The packaged elastomer composite of claim 1, wherein the at least one filler is selected from rice husk silica, lignin, nanocellulose, and hydrothermal carbon.

28. (canceled)

29. The packaged elastomer composite of claim 1, wherein the at least one elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof.

30. (canceled)

31. The packaged elastomer composite of claim 1, wherein the at least one elastomer is selected from natural rubber, polyisoprene rubber, butadiene rubber, and blends thereof.

32. The packaged elastomer composite of claim 1, wherein the at least one elastomer comprises at least 30% natural rubber and the at least one filler comprises at least 50% carbon black.

33. The packaged elastomer composite of claim 1, wherein the composite further comprises curing agents.

34. The packaged elastomer composite of claim 1, wherein the composite has a Payne ratio of at least 1.1, wherein the Payne ratio is G′(0.3%)/G′(51.5%), wherein G′(0.3%) is a dynamic storage modulus measured at 0.3% strain amplitude and G′(51.5%) is a dynamic storage modulus measured at 51.5% strain amplitude.

35. The packaged elastomer composite of claim 1, wherein the composite has a macrodispersion d₉₀ of no more than 80 μm, wherein d₉₀ is the area-equivalent diameter (μm) of particles of the filler in the composite.

36-37. (canceled)

38. The packaged elastomer composite of claim 1, wherein the composite has been packaged for a time period of at least 5 days.

39. (canceled)

40. A method of storing an elastomer composite, comprising:
sealing the elastomer composite in a container and storing the composite in the sealed container for a time period of at least 5 days, wherein:
the elastomer composite is uncured and comprises at least one elastomer and at least one filler; and
the container comprises at least one wall surrounding the composite wherein the at least one wall comprises at least one oxygen barrier layer such that the container has an oxygen transmission rate of no more than 100 cm³/(m²·day·atm) at 23° C. and 0% relative humidity.

41. The method of claim 40, wherein prior to the sealing, the method further comprises flushing the container interior with at least one gas that is nonreactive with the composite and/or subjecting the container interior to a vacuum.

42. The method of claim 40, wherein the sealed container has an atmosphere comprising at least 90% of at least one gas that is nonreactive with the elastomer composite.

43. The method of claim 40, wherein the sealed container is under vacuum.

44. The method of claim 40, wherein the composite is stored in the sealed container for a time period of at least 14 days.

45. The method of claim 40, wherein prior to the sealing, the method further comprises heat-treating the composite at a temperature of at least 40° C.

46. The method of claim 40, wherein at the time of the sealing, the composite has a probe temperature of at least 40° C.

47. The method of claim 40, wherein the composite is prepared by combining at least a solid elastomer and a wet filler comprising a filler and a liquid, wherein the liquid is present in an amount of at least 15% by weight based on total weight of wet filler.

48. A method of maintaining or enhancing at least one property of an elastomer composite or a compound formed from the composite, comprising:
storing the elastomer composite in a sealed container for a time period of at least 5 days, wherein:
the elastomer composite is uncured and comprises at least one elastomer and at least one filler; and
the container comprises at least one wall surrounding the composite wherein the at least one wall comprises at least one oxygen barrier layer such that the container has an oxygen transmission rate of no more than 100 cm³/(m²·day·atm) at 23° C. and 0% relative humidity.

49. The method of claim 48, wherein the elastomer composite is stored in the sealed container for a time period of at least 14 days.

50. The method of claim 48, wherein the stored elastomer composite or a compound formed from the stored elastomer composite has a Payne ratio that is reduced by at least 10% relative to the Payne ratio of the composite prior to sealing the package,
wherein the Payne ratio is G′(0.3%)/G′(51.5%), wherein G′(0.3%) is a dynamic storage modulus measured at 0.3% strain amplitude and G′(51.5%) is a dynamic storage modulus measured at 51.5% strain amplitude.

51. The method of claim 48, the compound formed from the stored elastomer composite has a maximum tan δ value that is reduced by at least 10% relative to the maximum tan δ value of the composite prior to sealing the package.

52-60. (canceled)
